(19) United States
(12) Patent Application Publication
(10) Pub. No.: US 2013/0278846 A1
(43) Pub. Date: Oct. 24, 2013

(54) ILLUMINATION SYSTEMS AND METHODS

(71) Applicants: Robert L. Holman, San Jose, CA (US); Matthew B. Sampsell, San Jose, CA (US)

(72) Inventors: Robert L. Holman, San Jose, CA (US); Matthew B. Sampsell, San Jose, CA (US)

(73) Assignee: QUALCOMM MEMS Technologies, Inc., San Diego, CA (US)

(21) Appl. No.: 13/454,994

(22) Filed: Apr. 24, 2012

(51) Int. Cl. G02F 1/1335; F21V 13/12; F21V 13/08; F21V 17/00; G09F 13/18; G02B 26/00; G02F 1/167; F21V 7/00; F21V 13/04

(52) U.S. Cl. 349/14; 362/297; 362/608; 362/235; 362/602; 359/290; 359/296; 29/825

(57) ABSTRACT

This disclosure provides systems, methods, and apparatuses for providing illumination in, for example, a display device. One or more light emitters can emit light into a light guide plate that is configured to distribute the light across an array of display elements. A substantially etendue-preserving reflector between the light emitters and the light guide can at least partially collimate light propagating in a single plane of collimation. In some implementations, a lenticular film, or other optical elements, can be used to increase divergence of the light in a plane orthogonal to the plane of collimation. The light guide can include light extraction elements, which can be frusta-shaped features for turning light out of the light guide for illuminating the display. In some implementations, a flexible electrical interconnection circuit can be used to provide power and/or signals to the light emitters, thereby providing a flexible circuit illumination system.

### TECHNICAL FIELD

This disclosure relates to systems and methods for providing illumination, such as for display devices or other electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Some display devices can include a light guide configured to receive light from at least one light emitters and distribute the light across an array of display elements to form an image. In some cases, a light emitter can be directly optically coupled to the light guide. For light emitters providing a wide angle output of light, some light entering the light guide can escape early (e.g., by overcoming total internal reflection (TIR)) and can reduce the uniformity of illumination provided to the display.

### SUMMARY

The systems, methods and devices of the disclosure each have several innovative aspects, no single one of which is solely responsible for the desirable attributes disclosed herein.

One innovative aspect of the subject matter described in this disclosure can be implemented in an illumination system that includes a light emitter, a light guide, and a substantially etendue-preserving reflector. The light guide can include an entrance aperture and a continuous output surface. At least a portion of the continuous output surface can be optically transmissive. The light guide can include a plurality of light extraction features. Collective action of the plurality of light extraction features can result in light transmission through the continuous output surface. The substantially etendue-preserving reflector can be optically coupled between the light emitter and the entrance aperture of the light guide. The reflector can be configured to at least partially collimate light propagating from the light emitter in a single plane of collimation, which can be orthogonal to the continuous output surface of the light guide. The plurality of light extraction features of the light guide can be configured to turn light propagating from the reflector.

The reflector can be configured to collimate light propagating from the light emitter in the plane of collimation and through an output aperture of the reflector to about ±60°, about ±40°, about ±25°, or about ±20° in air. The light emitter can include at least one of a light emitting diode (LED) chip, an organic light emitting diode (OLED), and a phosphor layer.

In some implementations, the light propagating out of the reflector can be at least one of an axially directed single lobed beam, a single lobed beam directed at an angle to an optical axis of the reflector, and two or more lobes with at least one of the two or more lobes directed above the optical axis of the reflector and at least one of the two or more lobes directed below the optical axis of the reflector. The reflector can include an upper trough reflector portion producing a degree of angular collimation substantially below the optical axis of the reflector and a lower trough reflector portion producing a second degree of angular collimation substantially above the optical axis of the reflector. In some implementations, the illumination system can include a holographic film between the reflector and the light guide.

The illumination system can include a lenticular film between the reflector and the light guide, and the lenticular film can be configured to increase divergence of light propagating from the reflector in a plane substantially orthogonal to the plane of collimation of the reflector.

The reflector can include an upper reflective surface and a lower reflective surface, and one of the upper reflective surface and the lower reflective surface can be longer than the other of the upper reflective surface and the lower reflective surface. In some implementations, the reflector can be a compound parabolic concentrator (CPC) trough. In some implementations, the reflector can include a vertical stabilizer.

The plurality of light extraction feature can include frusta light extraction features configured to turn light propagating from the reflector.

In some implementations, a display device can include the illumination system and an array of display elements. The light guide can be configured to turn light propagating out of the reflector towards the display elements. The display elements can include at least one of liquid crystal displays (LCD), electrophoretic displays, and interferometric modulators (IMOD). In some implementations, the display elements are reflective.

In some implementations, an apparatus can include a display that includes the illumination system and a processor that is configured to communicate with the display. The processor can be configured to process image data. The apparatus can also include a memory device that can be configured to communicate with the processor.

The apparatus can include a driver circuit configured to send at least one signal to the display. The apparatus can include a controller configured to send at least a portion of the image data to the driver circuit. The apparatus can include an image source module configured to send the image data to the processor. The image source module can include at least one of a receiver, transceiver, and transmitter. The apparatus can include an input device configured to receive input data and to communicate the input data to the processor.

One innovative aspect of the subject matter described in this disclosure can be implemented in an illumination system that includes a light emitter, a light guide, and means for reflecting light propagating from the light emitter. The light guide can include an entrance aperture, a continuous output surface, and a plurality of light extraction features. At least a portion of the continuous output surface can be optically transmissive. Collective action of the plurality of light extraction features can result in light transmission through the continuous output surface. The reflecting means can be configured to substantially preserve etendue. The reflecting means can be optically coupled between the light emitter and the entrance aperture of the light guide. The reflecting means can be configured to at least partially collimate light propagating from the light emitter in a single plane of collimation, which can be orthogonal to the continuous output surface of the light guide. The plurality of light extraction features of the light guide can be configured to turn light propagating from the reflecting means. In some implementations, the reflecting means can include a reflector.

The plurality of light extraction features can include frusta light extraction features configured to turn light propagating from the reflecting means.

The illumination system can include means for increasing divergence of light propagating out of the reflecting means in a plane substantially orthogonal to the plane of collimation of the reflecting means. In some implementations, the divergence increasing means can include a lenticular film between the reflecting means and the light guide.

One innovative aspect of the subject matter described in this disclosure can be implemented in a method of making an illumination system. The method can include optically coupling an input aperture of a substantially etendue-preserving reflector to a light emitter. The method can include optically coupling an output aperture of the reflector to an entrance aperture of a light guide. The light guide can include a continuous output surface and a plurality of light extraction features. At least a portion of the continuous output surface can be optically transmissive. Collective action of the plurality of light extraction features can result in light transmission through the continuous output surface. The reflector can be configured to at least partially collimate light propagating from the light emitter in a single plane of collimation, which can be orthogonal to the continuous output surface of the light guide. The plurality of light extraction features of the light guide can be configured to turn light propagating from of the reflector.

The method can include providing a lenticular film between the reflector and the light guide. In some implementations, the plurality of light extraction features can include frusta light extraction features configured to turn light propagating from the reflector.

One innovative aspect of the subject matter described in this disclosure can be implemented in an illumination system that includes a flexible electrical interconnection circuit having a first side and a second side opposite the first side. The electrical interconnection circuit can include a plurality of surface mounted electrical pathways. The illumination system can include a light emitter coupled to the electrical interconnection circuit and a reflector having an input aperture that is substantially proximate to an output aperture of the light emitter. The reflector can include an upper shaped reflector sheet on the first side of the electrical interconnection circuit and a lower shaped reflector sheet on the second side of the electrical interconnection circuit.

The illumination system can include an upper spacer between the first side of the electrical interconnection circuit and the upper shaped reflector, and a lower spacer between the second side of the electrical interconnection circuit and the lower shaped reflector. The upper spacer can be thicker than the lower spacer. The upper spacer and the lower spacer can have a substantially similar thickness.

The light emitter can be mounted to the first side of the electrical interconnection circuit. The light emitter can be mounted to an end of the electrical interconnection circuit. The light emitter can include a blue light-emitting diode (LED) chip and a yellow phosphor. The illumination system can include a light guide region between the blue LED chip and the yellow phosphor. The light emitter can include at least one of a light emitting diode (LED) chip, an organic light emitting diode (OLED), and a phosphor layer.

The reflector can include a substantially etendue-preserving reflector optically coupled to the light emitter. The reflector can be configured to at least partially collimate light propagating from the light emitter in a single plane of collimation. A volume between the upper shaped reflector sheet and the lower shaped reflector sheet can be occupied by air.

The reflector can include a vertical stabilizer. The vertical stabilizer can include a lenticular film.

A display device can include the illumination system, an array of display elements, and a light guide optically coupled to the reflector of the illumination system. The light guide can be configured to turn light propagating from the reflector towards the display elements.

The display elements can include at least one of liquid crystal displays (LCD), electrophoretic displays, and interferometric modulators (IMOD). In some implementations, the display elements can be reflective.

An apparatus can include a display including the illumination system. The apparatus can also include a processor that is configured to communicate with the display, and the processor can be configured to process image data. A memory device can be configured to communicate with the processor. A driver circuit can be configured to send at least one signal to the display. A controller can be configured to send at least a portion of the image data to the driver circuit. An image source module can be configured to send the image data to the processor. The image source module can include at least one of a receiver, transceiver, and transmitter. An input device can be configured to receive input data and to communicate the input data to the processor.

One innovative aspect of the subject matter described in this disclosure can be implemented in a illumination system that includes means for flexibly interconnecting electrical components. The interconnecting means can have a first side and a second side opposite the first side The interconnecting means can include a plurality of surface mounted electrical pathways. The illumination system can include a light emitter coupled to the interconnecting means. The illumination system can include means for reflecting light propagating from the light emitter. The reflecting means can have an input aperture that is substantially proximate to an output aperture of the light emitter. The reflecting means can include upper reflecting means on the first side of the interconnecting means and lower reflecting means on the second side of the interconnecting means.

The interconnecting means can include a flexible electrical interconnection circuit. The reflecting means can include a reflector. The upper reflecting means can include an upper shaped reflector. The lower reflecting means can include a lower shaped reflector.

The illumination system can include upper means for spacing the first side of the interconnecting means and the upper reflecting means and lower means for spacing the second side of the interconnecting means and the lower reflecting means. The upper spacing means can include an upper spacer. The lower spacing means can include a lower spacer.

The reflecting means can include means for vertical stabilizing. The vertical stabilizing means can include a vertical stabilizer.

One innovative aspect of the subject matter described in this disclosure can be implemented in a method of making a illumination system. The method can include disposing an input aperture of a reflector substantially proximate to an output aperture of a light emitter. The method can include coupling the light emitter to a flexible electrical interconnection circuit. The flexible electrical interconnection circuit can have a first side and a second side opposite the first side. The electrical interconnection circuit can include a plurality of surface mounted electrical pathways. The reflector can include an upper shaped reflector sheet on the first side of the electrical interconnection circuit. The reflector can include a lower shaped reflector sheet on the second side of the electrical interconnection circuit.

The method can include providing an upper spacer between the first side of the flexible electrical interconnection circuit and the upper shaped reflector sheet and providing a lower spacer between the second side of the flexible electrical interconnection circuit and the lower shaped reflector sheet. In some implementations, the method can include providing a vertical stabilizer for the reflector.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows a perspective view of an example implementation of an edge light source.

FIG. 10 shows a cross-sectional view of the edge light source of FIG. 9 taken through a light emitter in the xz-plane of FIG. 9.

FIG. 11 shows a cross-sectional view of the edge light source of FIG. 9 taken through a light emitter in the xz-plane of FIG. 9 coupled to a light guide.

FIG. 12 shows an exploded cross-sectional view of another example implementation of an edge light source and a light guide.

FIG. 13 shows a coupled cross-sectional view of the edge light source and light guide of FIG. 12.

FIG. 14 shows an example implementation of a portion of a display including an edge light source.

FIG. 15 shows a cross-sectional view showing example implementations of a light extraction element of a light guide.

FIG. 16 shows another example implementation of a display including an edge light source.

FIG. 17 schematically shows a side view of an example implementation of an edge light source producing an axial lobe.

FIG. 18 schematically shows a side view of an example implementation of an edge light source producing a skewed lobe.

FIG. 19A schematically shows a side view of an example implementation of an edge light source producing multiple lobes.

FIG. 19B shows a cross-sectional view of an example implementation of an edge light source including rotated upper and lower reflector portions.

FIG. 19C shows a cross-sectional view of an example implementation of an edge light source including a tilted light emitter and reflector.

FIG. 19D shows a cross-sectional view of an example implementation of an edge light source including a reflector that includes a prismatic trough.

FIG. 19E shows a cross-sectional view of an example implementation of an edge light source including an asymmetric reflector.

FIG. 20 shows a perspective view of an edge light source including vertical stabilizers.

FIG. 21 shows a cross-sectional view in an xy-plane of an edge light source including posts for vertical stabilizers.

FIG. 22 shows a cross-sectional view in an xy-plane of an edge light source including pillar lenses.

FIG. 23 shows a cross-sectional view in an xy-plane of an edge light source including a lenticular film.

FIG. 24 shows a cross-sectional view in an xy-plane of an example edge light source including additional collimating elements and light directed into a light guide.

FIG. 25 shows a cross-sectional view in an xy-plane of an example implementation of an edge light source and light directed into a light guide.

FIG. 26 shows a perspective view of an example implementation of a flexible circuit edge light source.

FIG. 27A shows a cross-sectional view of the flexible circuit edge light source of FIG. 26 taken through a light emitter in the xz-plane of FIG. 26.

FIG. 27B shows a detailed cross-sectional view of light emitter and reflector portions 104a and 104b of the flexible circuit edge light source of FIG. 26 taken in the xz-plane.

FIG. 28A shows a cross-sectional view in an xz-plane of another example implementation of a flexible circuit edge light source.

FIG. 28B is an exploded view of a portion of an example implementation of a flexible electrical interconnection circuit.

FIG. 28C is an exploded view of a portion of another example implementation of a flexible electrical interconnection circuit.

FIG. 29 shows a cross-sectional view of a portion of an example implementation of a flexible electrical interconnection circuit.

FIG. 30 shows a cross-sectional view of a portion of another example implementation of a flexible electrical interconnection circuit.

FIG. 31 is a flowchart showing an example implementation of a method for making an illumination system.

FIG. 32 is a flowchart showing an example implementation of a method for making an illumination system.

FIGS. 33A and 33B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Some display systems utilize ambient light for illumination of the integral image display devices. In dark or low-light environments, ambient light may be insufficient or non-existent. An illumination system can be used to illuminate a display device, for example as a back light (providing outward light directed to behind and through the displayed image) or a front light (providing downward directed light from above and through the displayed image) in either case as for example, by light released from the output aperture of a light guide system. A light guide can be edge-illuminated by one or more light emitters (e.g., light emitting diodes (LEDs)) and the light guide can be configured to distribute the light across the display panel's image output aperture. Collimating optics can be used to modify the light input into the light guide to improve the uniformity of distribution of light in the light guide and the efficiency with which light is emitted through the displayed image, thereby increasing the brightness of the light emitted from the light guide. For example, in some implementations, the collimating optics can be configured to at least partially collimate or to condense light in a single plane of angular narrowing, this plane generally being in a plane orthogonal to the light guide's upper and/or lower bounding surfaces so as to increase the overlap between the light propagating in the light guide and the associated light extracting elements that cause the light to leave the light guide and pass through and thereby illuminate the displayed image. Flexible electrical interconnection circuits can be used to provide power and/or signals to the light emitters. Layers of a flexible electrical interconnection circuit or layers compatible with the layers of a flexible electrical interconnection circuit can be used to form or support the collimating optics, while providing the optics with a precise spacing.

Particular implementations of the subject matter described in this disclosure can be implemented to realize one or more of the following potential advantages. Use of collimating or condensing optics and/or other optical elements to modify the light input into a light guide can increase the uniformity of light used to illuminate a display and can increase the brightness of the display. In some implementations, brightness of the display can be increased by about 15% to 38%, in other implementations brightness gains as high as 200% are possible. The collimating optics can have a thin construction, in some cases having a thickness that is less than or equal to the thickness of the light guide. The collimating optics can be incorporated into an image display device without increasing the thickness of the device. Flexible electrical interconnection circuitry can be used to provide power and/or signals to the illumination system, and the flexible electrical interconnection circuitry can conform to a housing or other features of the device to reduce that the amount of space in the device used by the illumination system.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

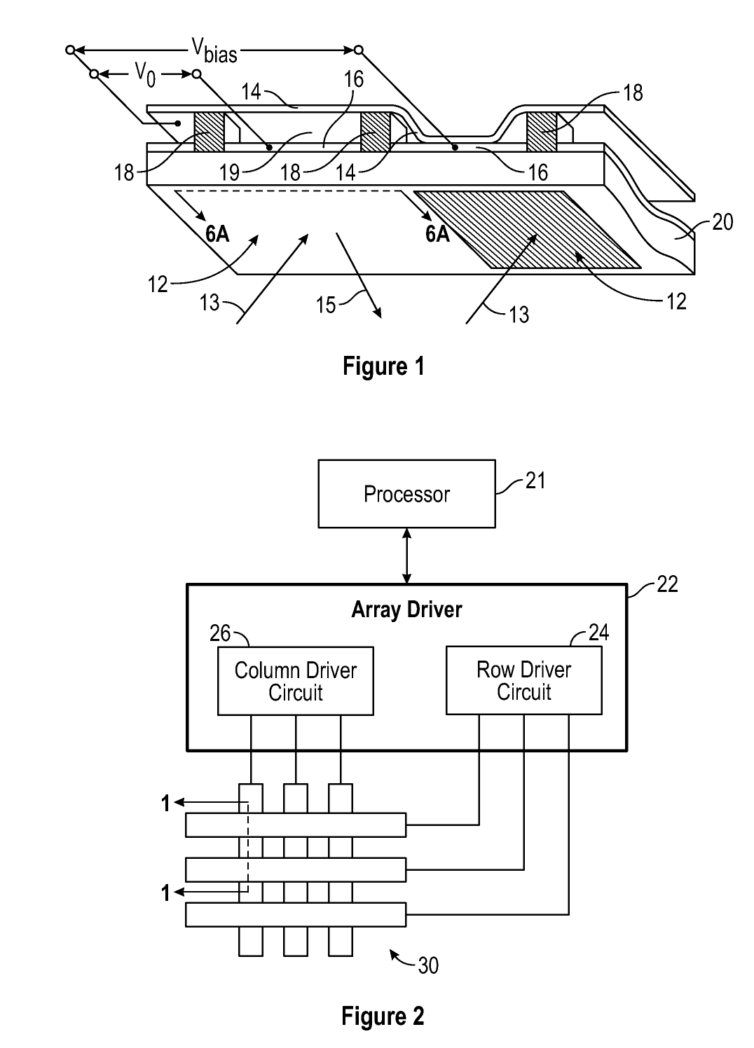

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

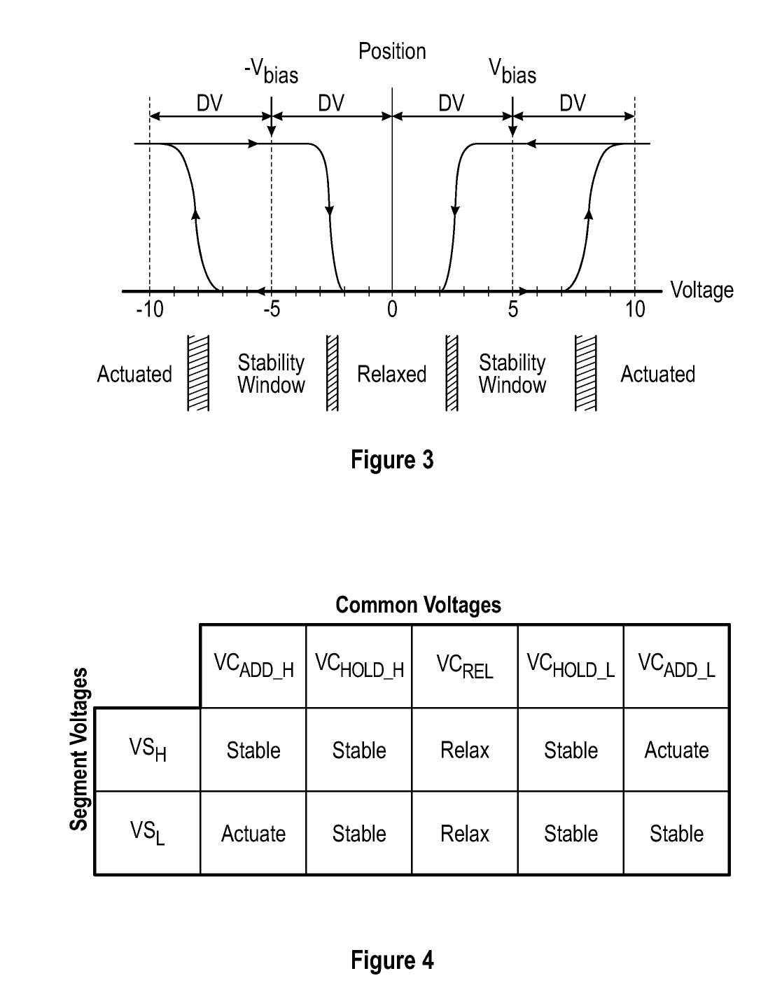

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

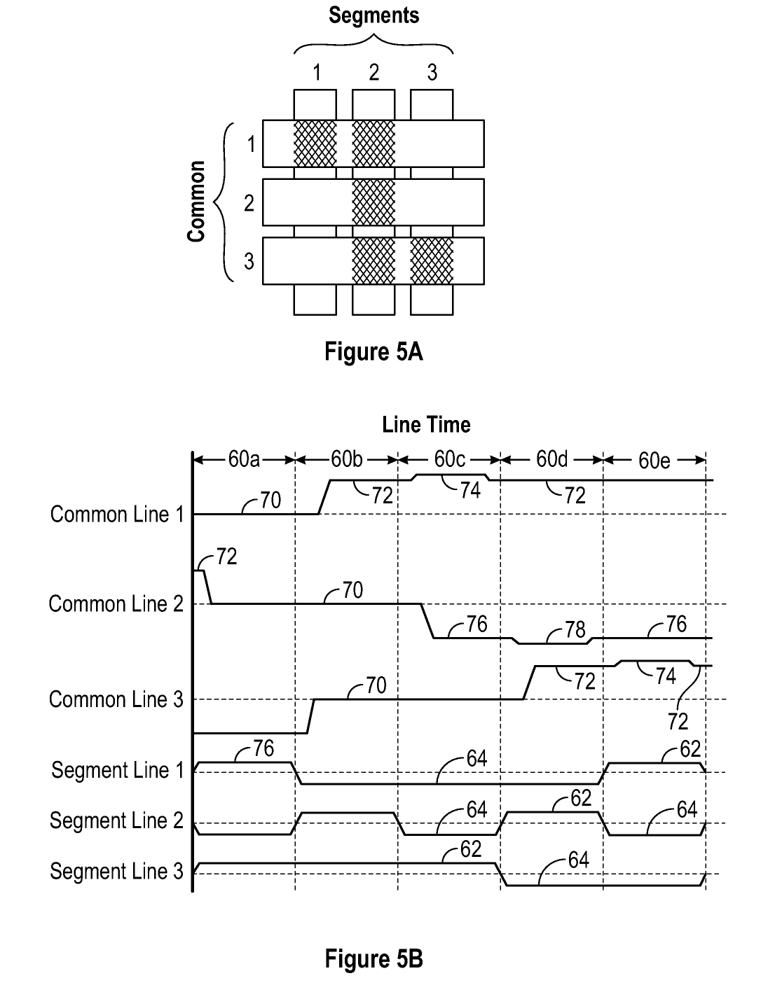

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

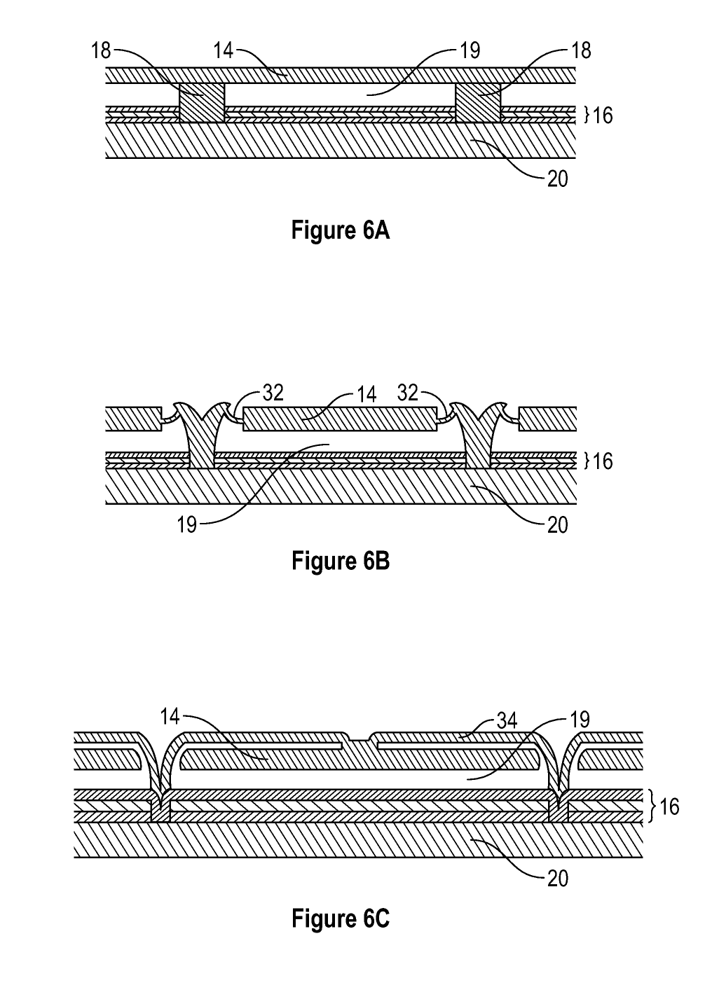

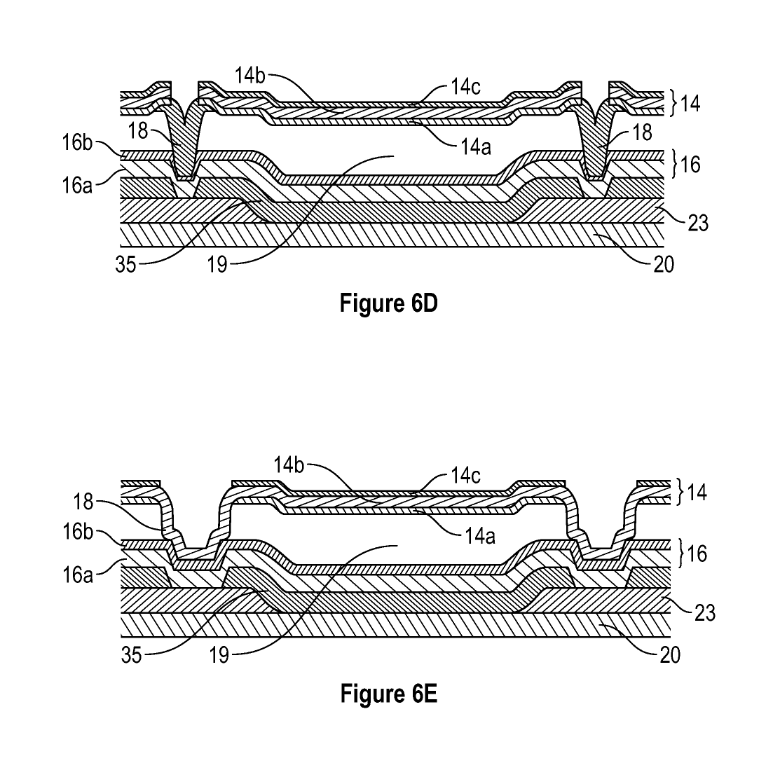

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

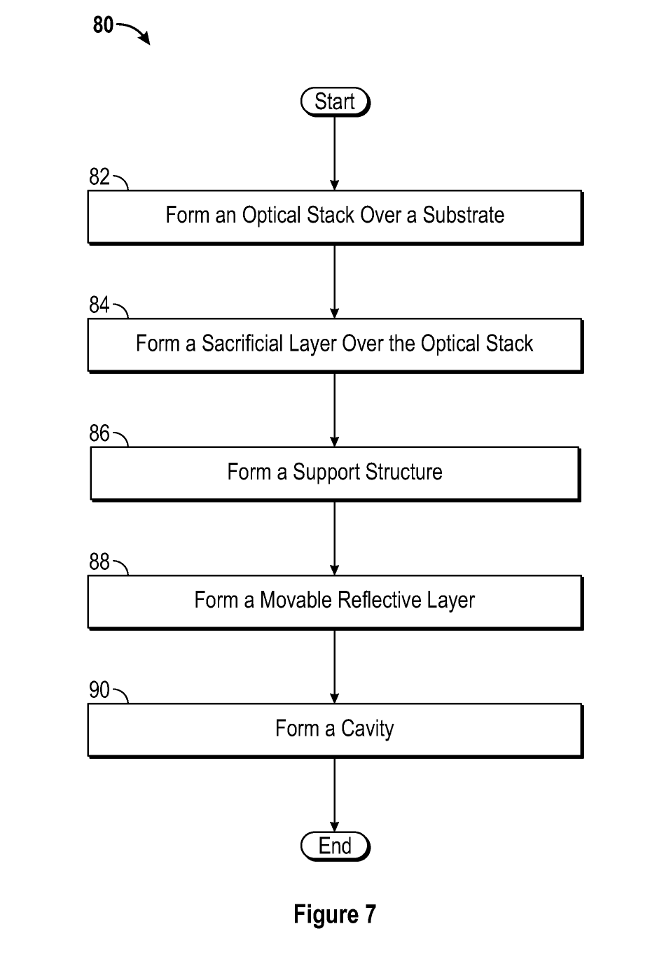

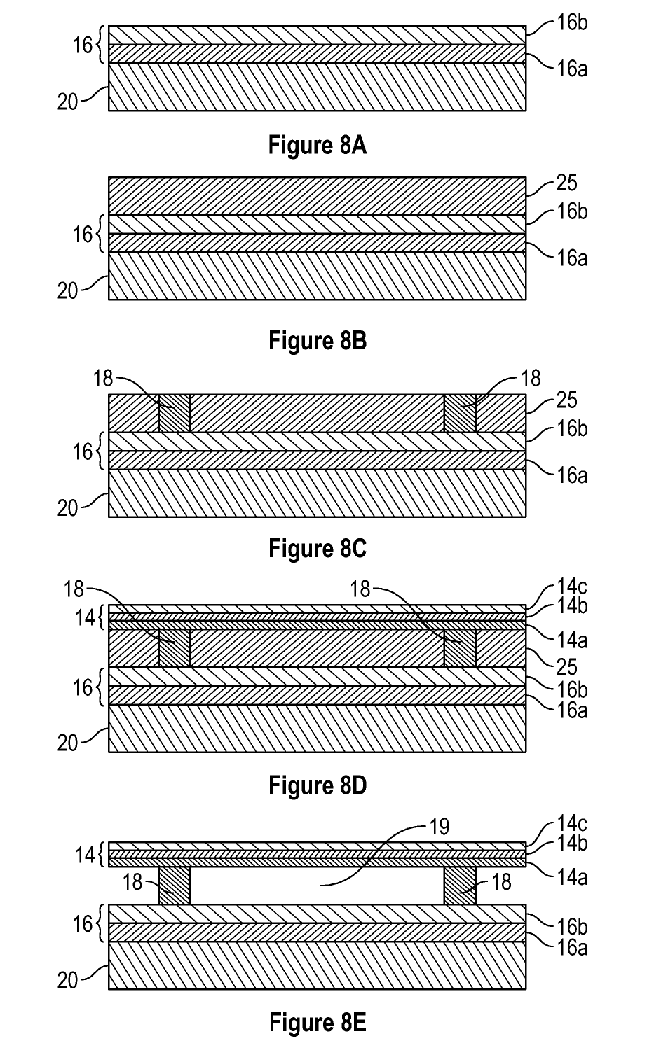

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

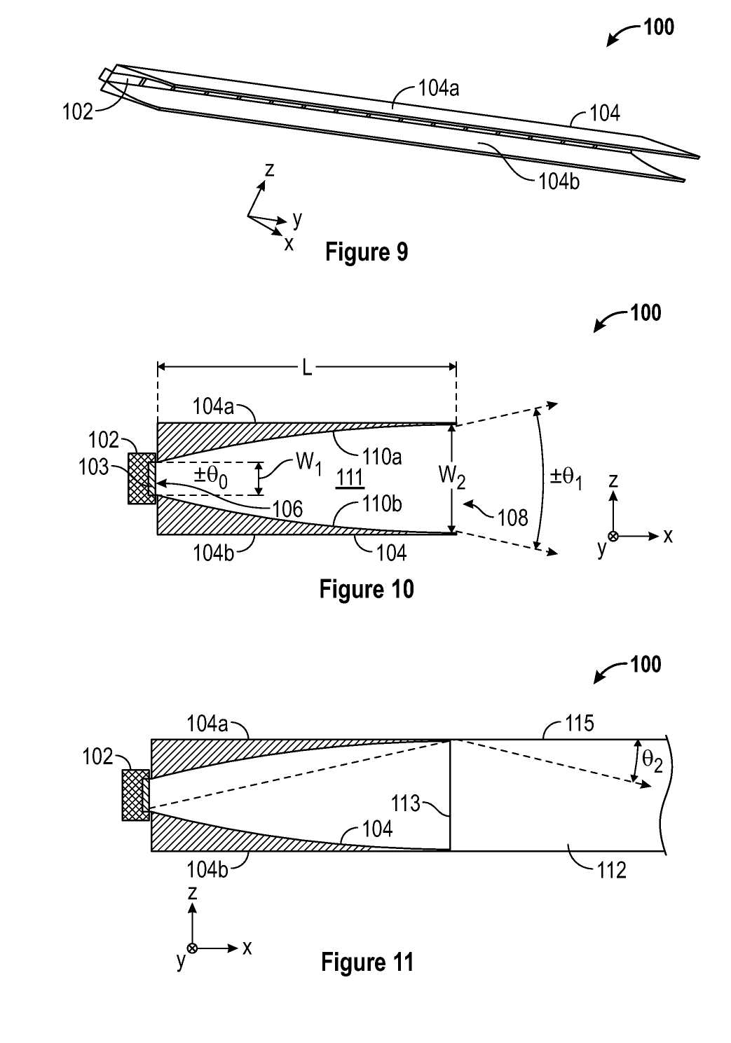

FIG. 9 shows a perspective view of an example implementation of an edge light source 100. The edge light source 100 can, for example, be used to illuminate a display device as discussed herein. The edge light source 100 includes one or more light emitters 102 and a reflector 104 that is configured to at least partially collimate light from the one or more light emitters 102. The reflector 104 can include an upper or first reflector portion 104a and a lower or second reflective portion 104b. Although the edge light source 100, as well as various other implementations discussed herein, can be oriented differently than shown in the illustrated implementations, the terms upper, upward, above, top, etc. are used herein to generally refer to an increase or relatively high value in the z-direction, and the terms lower, downward, below, bottom, etc. are used herein to generally refer to a decrease or relatively low value in the z-direction. The particular orientations shown in the illustrated implementations are provided merely as examples. The edge light source 100 can have a generally elongate shape along a longitudinal axis (parallel or substantially parallel to the y-axis in FIG. 9), and can be configured to at least partially collimate light in a plane of collimation (parallel or substantially parallel to the xz-plane in FIG. 9) that is transverse or substantially transverse to the longitudinal axis. In the implementation shown in FIG. 9, multiple light emitters 102 are shown arranged substantially linearly along the longitudinal axis of the edge light source 100. In some implementations, the edge light source 100 can include a single, elongate light emitter, or the edge light source 100 can include a different number or arrangement of light emitters 102 than that shown in FIG. 9.

In some implementations, the one or more light emitters 102 can be surface-emitting light emitters. FIG. 10 shows a cross-sectional view of the edge light source 100 taken through a light emitter 102 in the xz-plane of FIG. 9. As can be seen in FIG. 10, the light emitter 102 can include a light emitting surface 103. In some implementations, the light emitter 102 includes a light emitting diode (LED) chip, which can be oriented so that the light emitting surface of the LED chip is the light emitting surface 103 or so that the light emitting surface of the LED chip is proximate to (e.g., substantially proximate to) the light emitting surface 103. In some implementations, the light emitter 102 includes an organic light emitting diode (OLED). In some implementations, the light emitter 102 includes a phosphor layer configured to receive light (e.g., from an LED) and to emit light at the surface 103 of the light emitter 102. Other light emitter configurations can also be used. For example, the surface 103 of the light emitter 102 can include a color filter, a diffuser, or other optical feature configured to emit light (directly or indirectly). In some implementations, the one or more light emitters 102 can be substantially Lambertian, having an emission distribution of about ±90° (about ±60° full-width-half-maximum (FWHM)) from the direction of the x-axis.

The reflector 104 can be configured to at least partially collimate light in the xz-plane such that light exiting the reflector 104 in the xz-plane has an emission distribution of ±θ₁, which can be, for example about ±60°, about ±45°, about ±40°, about ±35°, about ±35°, about ±25°, about ±20°, less than about ±60°, greater than about ±20°, between about ±60° and about ±20°, between about ±40° and about ±25°, and the like. In some implementations, the at least partially collimated light can have a substantially sharp cutoff at the ends of the emission distribution, as opposed to the soft, gradual fade of Lambertian distribution. As can be seen in FIG. 10, the upper reflector portion 104a can include a reflective surface 110a that faces generally downward (in the illustrated orientation) or towards the lower reflector portion 104b. The reflective surface 110a can be a mathematically shaped surface and can substantially conform, for example, to a portion of a parabola in the xz-plane. The lower reflector portion 104b can include a reflective surface 110b that faces generally upward (in the illustrated orientation) or towards the upper reflector portion 104a. The reflective surface 110b can be a mathematically shaped surface and can substantially conform, for example, to a portion of a parabola in the xz-plane. The upper reflector portion 104a and the lower reflector portion 104b can be spaced apart, forming an input aperture 106 at a first end and an output aperture 108 at a second end. The input aperture 106 can have a width w₁ along the z-axis that is smaller than a width w₂ of the output aperture 108 along the z-axis.

In some implementations, the reflector 104 can be a substantially etendue-preserving reflector. In some implementations, the mathematical shape(s) of the reflective surface(s) 110a and/or 110b can be governed by Sine Law reflector design. For example, if the light emitter 102 outputs light over a width w₁ and an emission distribution of ±θ₀ and light exits the reflector 104 over a width w₂ and an emission distribution of ±θ₁, then w₁×sin θ₀ can substantially equal w₂×sin θ₁, and the distance L between the input aperture 106 and the output aperture 108 can substantially equal 0.5×(w₁+w₂)/tan θ₁. In an implementation in which the emission distribution ±θ₀ of the light emitter 102 is about ±90°, w₁×sin θ₀ is w₁×sin 90°, which approaches unity and thus w₁ can substantially equal w₂×sin θ₁. In an implementation in which the emission distribution ±θ₀ of the light emitter 102 is about ±90°, and the emission distribution ±θ₁ of the reflector 104 is about ±25°, the width w₁ of the input aperture 106 can be about 0.21 millimeters (mm), the width w₂ of the output aperture 108 can be about 0.5 mm, and the distance between the input aperture 106 and the output aperture 108 can be about 0.76 mm. Various other dimensions can be selected and calculated using Sine Law. For example, one or more variable may be known, such as the width w₁ (e.g., based at least partially on the light emitter 102, based at least partially on the light emitting surface 103, etc.), the width w₂ (e.g., based at least partially on the width of a light guide), the emission distribution ±θ₀ (e.g., based at least partially on the type of light emitter 102), the emission distribution ±θ₁ (e.g., based at least partially on the design of the edge light source, based on properties of the light guide, etc.), and the distance L (e.g., based at least partially on the design of the edge light source, based at least partially on properties of a display device, etc.), which can allow for calculation of one or more unknown variables. In some implementations, the light emitting surface 103 of the light emitter 102 can substantially fill the input aperture 106 along the z-axis. The upper end of the input aperture 106 can be located at substantially the focal point of the parabolic curvature of the lower reflective surface 110b, and the lower end of the input aperture 106 can be located at substantially the focal point of the parabolic curvature of the upper reflective surface 110a. The first parabolic curve (associated with the upper reflective surface 110a) can be angled with respect to the second parabolic curve (associated with the lower reflective surface 110b) to form the reflector 104. In some implementations, the reflector cross-sectional shape (e.g., shown in FIG. 10) can be extruded, or otherwise formed into an elongate reflector 104, which can be, for example, a compound parabolic concentrator (CPC) trough, or a portion of a reflector 104 (such as portions 104a or 104b).

In some implementations, the space 111 between the reflector portions 104a and 104b can be filled with air, although the space 111 can include a non-gaseous substantially transparent material (e.g., a dielectric material). For example, a solid material (e.g., glass or transparent plastic such as polycarbonate, acrylic, or the like) can be formed to have substantially the same shape as the space 111 between the reflector portions 104a and 104b. In some implementations, including a non-gaseous material in the space 111 can change the amount of collimation provided by the reflector portions 104a and 104b as compared to the space 111 being filled with air or another gas, depending on the properties of the non-gaseous material. The reflector portions 104a and 104b can be mounted onto the sides of the solid material so that the solid material can be used as a spacer and can be configured to position the reflector portions 104a and 104b to conform with Sine Law. In some implementations, light can propagate through the solid material and can be reflected by the reflector portions 104a and 104b in substantially the same manner as if the space 111 were occupied by air. In some implementations, a material (e.g., glass or transparent plastic such as polycarbonate, acrylic, or the like) can be positioned in the space 111 to modify the propagation of light in the space 111. In some implementations, the mathematical shapes of one or both of the reflective portions 104a and 104b can be modified to compensate or account for the optical modifications introduced by the material occupying the space 111.

FIG. 11 shows a cross-sectional view of the edge light source 100 of FIG. 9 taken through a light emitter in the xz-plane of FIG. 9 coupled to a light guide 112. The edge light source 100 can include a light emitter 102 (e.g., a surface emitting light emitter), a light guide 112, and a reflector 104 (which can be a substantially etendue-preserving reflector) can be coupled between the light emitter 102 and the light guide 112. The reflector 104 can be configured to at least partially collimate light propagating from the light emitters in a single plane of collimation (e.g., the xz-plane). The light guide 112 can be configured to turn light propagating from the reflector 104, as discussed herein.

The light guide 112 can be a light guide plate for illuminating a display, as discussed herein. In some implementations, the light guide 112 includes or is made of a material that is configured to guide light by total internal reflection (TIR), such as polycarbonate, acrylic, glass, and the like. In some implementations, the light guide 112 has a critical angle θ₂ that is greater than or equal to the angle of distribution θ₁ of light leaving the reflector 104 in the xz-plane, such that all or substantially all of the light that exits the reflector 104 and enters the light guide 112 propagates at an angle below the critical angle θ₂ and can be guided by TIR within the light guide 112. The critical angle θ₂ for TIR of the light guide 112 can be, for example, at least about 30°, at least about 40°, less than about 50°, and/or less than about 45°. In some implementations, the critical angle θ₂ can be about 42°. The reflector 104 can reduce the amount of light that enters the light guide 112 at an angle higher than the critical angle θ₂, which light might otherwise escape the light guide 112 near the input, creating a bright region that can reduce uniformity of illumination from the light guide 112. The light escaping the light guide 112 near the input can also reduce the amount of light input into the light guide 112 that can be turned by the light guide 112, which can reduce the brightness of a display coupled to the light guide 112. By limiting the angle θ₁ at which the light is inputted into the light guide 112, the reflector 104 can increase the brightness and/or uniformity of light emitted from the light guide 112 as compared to a Lambertian light emitter that is optically coupled to the light guide 112 without collimation. In some implementations, brightness of a display device can be increased by between about 15% and about 38% by using a collimating reflector 104 to couple light into the light guide 112, as described herein. The light emitted from the light guide 112 can be used to illuminate a display in some implementations as described herein.

As can be seen in FIG. 11, the edge light source 100 can have a thickness that is similar (e.g., equal or substantially equal) in size to the thickness of the light guide 112. In some implementations, the thickness of the reflector 104 is less than or equal to the thickness of the light guide 112. The edge light source 100 and/or the light guide 112 can have a thickness of less than about 2.0 mm, less than about 1.0 mm, greater than 0.25 mm, and or greater than about 0.4 mm. In some implementations, the thickness of the edge light source 100 can be about 0.5 mm. Thus, the edge light source 100 can be incorporated into a display device for edge-illuminating a light guide 112 without increasing the thickness of the display device.

In some implementations, the reflector 104 is configured to at least partially collimate light in a single plane of collimation, for example the xz-plane in the implementations illustrated in FIGS. 9-11. Light propagating from the light emitter 102 parallel to the plane of collimation (the xz-plane) can be turned to increase the x-direction component of direction of travel for the reflected light. The reflector 104 can decrease divergence of the light away from the xy-plane, thereby collimating the light towards the xy-plane. Light propagating in the xy-plane (orthogonal to the plane of collimation (the xz-plane)) can exit without contacting the reflector 104. Light propagating in the xy-plane can preserve the distribution (e.g., Lambertian) defined by the light emitters 102 (e.g., because the edge light source 100 does not collimate light propagating in the xy-plane). In some implementations, substantially no light propagates from the light emitters 102 in the yz-plane. The reflector 104 can thereby provide substantially no collimation in any plane orthogonal to the plane of collimation (the xz-plane). In some implementations, the distribution of light exiting the reflector 104 can be similar to a cylindrical lens configured to have positive optical power in the xz-plane to decrease divergence of light propagating parallel to the xz-plane, and configured to have substantially no optical power in the xy-plane. The reflector 104 can at least partially collimate light in the intended plane of collimation (the xz-plane) more than in any other plane or direction.

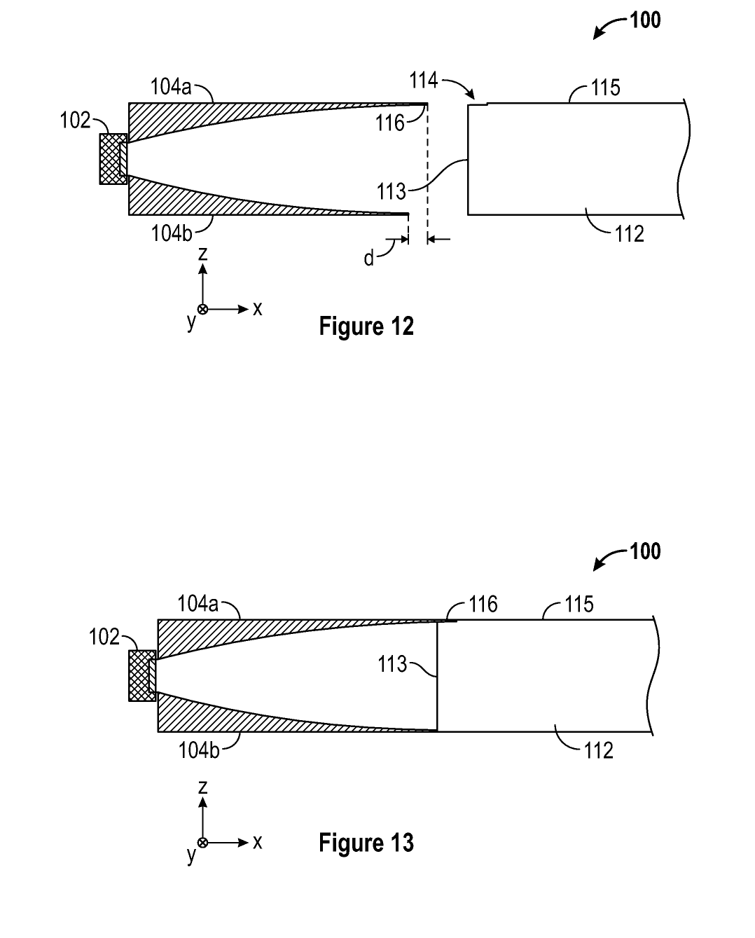

The input end (or entrance aperture) 113 of the light guide 112 can be positioned adjacent to the output aperture 108 of the reflector 104. In some implementations, the reflector 104 can be adhered to the end light guide 112. FIG. 12 shows an exploded cross-sectional view of another example implementation of an edge light source 100 and a light guide 112. FIG. 13 shows a coupled cross-sectional view of the edge light source 100 and a light guide 112 of FIG. 12. The light guide 112 and the reflector 104 include corresponding engagement features 114 and 116 configured to facilitate coupling between the light guide 112 and the reflector 104. FIG. 12 shows the light guide 112 and the reflector 104 in an exploded, disengaged configuration (e.g., prior to coupling or after decoupling). FIG. 13 shows the light guide 112 and the reflector 104 of FIG. 12 in an engaged configuration (e.g., after coupling). The light guide 112 can include an engagement feature 114, for example a groove or recess in an input end 113 thereof (e.g., as illustrated in FIGS. 12 and 13). The reflector 104 can include a corresponding or complementary engagement feature 116 configured to engage with the engagement feature 114 of the light guide 112, for example an overhand or ledge (e.g., as illustrated in FIGS. 12 and 13), that can facilitate coupling of the light guide 112 to the reflector 104. In the illustrated implementation, the upper reflector portion 104a is longer than the lower reflector portion 104b by a distance d. The overhang 116 is configured to fit with the recess 114 of the light guide 112. The distance d can be at least about 0.05 mm, at least about 0.075 mm, less than about 0.25 mm, less than about 0.15, between about 0.5 mm and about 0.25 mm, or between about 0.075 mm and about 0.15 mm. The distance d can be about 0.1 mm in some cases. In some implementations, an adhesive can be positioned on the recess 114 and/or on the extended portion 116 of the top reflector portion 104a. In some implementations, the top and bottom of the light guide 112 can both include grooves or recesses 114 configured to engage with the reflector 104 (e.g., having different properties such as length, thickness, pattern, etc.). In some implementations, a portion of the light guide 112 can extend through the output aperture 108 into the space between the upper reflector portion 104a and the lower reflector portion 104b (e.g., by about a distance d). In some implementations, the light guide 112 can be shaped and configured to extend into the space between the reflector portions 104a and 104b by a distance greater than the distance d.

In some implementations, the light guide 112 can have an output surface 115 (e.g., a continuous optically transmissive surface, which can be a plane surface extending, for example, across the xy-plane), and the light guide 112 can be configured to output light through the output surface 115 (e.g., using light extraction features as discussed below). In some implementations, the reflector 104 can be configured to at least partially collimate light propagating from the light emitter 102 in a single plane of collimation (e.g., the xz-plane), which can be orthogonal to the plane output surface 115 of the light guide 112.

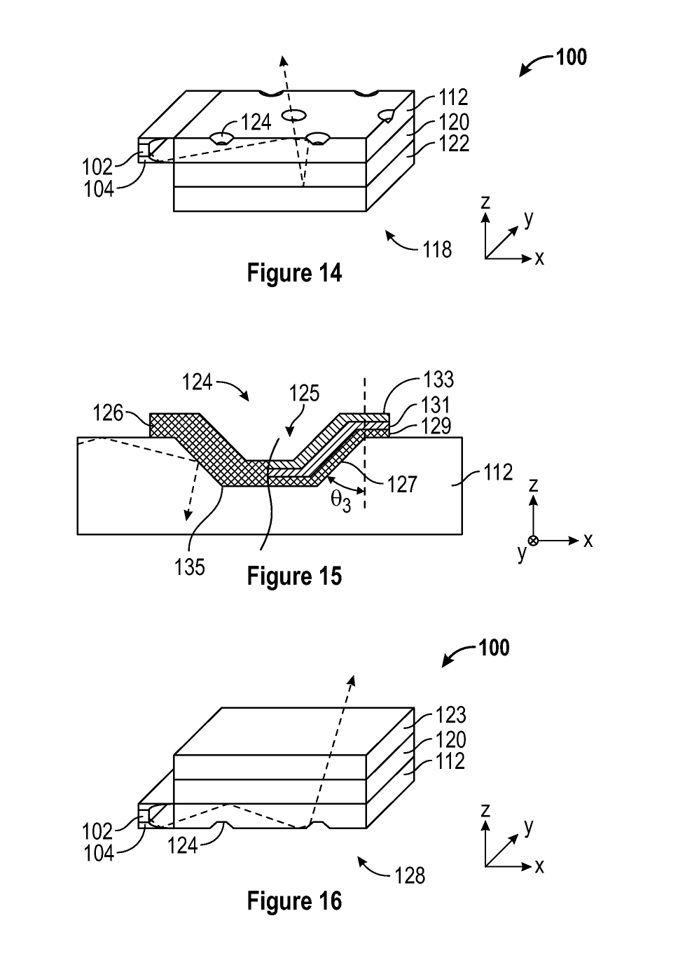

The edge light source 100 can be used to illuminate a display. FIG. 14 shows an example implementation of a portion of a display 118 including an edge light source 100. The edge light source 100 is configured to partially collimate light. The edge light source 100 of the display 118 can include one or more light emitters 102 (e.g., a linear array of surface-emitting LEDs) and a reflector 104 configured to at least partially collimate light in the xz-plane. A light guide 112 of the display 118 can be optically coupled to the reflector 104 of the edge light source 100 of the display 118 to receive light exiting the reflector 104, as discussed herein. The light guide 112 can be configured to propagate light by TIR, and the light guide 112 can include light extraction features 124 configured to turn light propagating in the light guide 112 so that the turned light exits the light guide 112 towards the display elements 122 of the display 118. In some implementations, a turn cone (e.g., the frusta light extraction features 124) with a metal reflection coating can redirect a portion of the light propagating in the light guide 112 (e.g., that portion of the light that strikes the cone surface). The light that is redirected to an angle that is greater than the critical angle θ₂ as measured from a surface of the light guide 112 (e.g., the bottom surface in FIG. 14) can overcome total internal reflection, so that the light is no longer bound to the light guide 112 and is emitted out of the light guide 112 (e.g., in a downward direction in FIG. 14) to illuminate a reflective image display layer 122 (e.g., which can include interferometric modulators). In FIG. 14, the display elements 122 can be reflective display elements configured to reflect light to form an image viewable to a user. The display elements 122 can include, for example, a plurality of interferometric modulators, which can be arranged in an array to form pixel elements, as discussed herein. In some implementations, the display 118 can include a substrate layer 120, which can be between the light guide 112 and the display elements 122. In some implementations, the substrate 120 can be used for forming other layers (e.g., layers of the display elements 122, diffusers, color filters, black masks, etc.). In some implementations, the light guide 112 can be used as a substrate for forming other layers (e.g., layers of the display elements 122, diffusers, color filters, black masks, etc.). In certain such implementations, the substrate layer 120 can be omitted. The display 118 can include other layers and features (e.g., a diffuser positioned between the light guide 112 and the display elements 122, a cladding layer, a protective top-coat, pressure sensitive adhesives, a touch sensitive panel, etc.), but are not illustrated in FIG. 14 for simplicity.

Various types of light extraction features 124 can be used to redirect light that is propagating through the light guide 112 towards the display elements 122. For example, the light extraction features 124 can be configured to provide a substantially uniform distribution of light from the light guide 112 towards the display elements 122. In FIG. 14, the light guide includes frusta light extraction features 124 dispersed across the surface of the light guide 112. The light extraction features 124 can be recesses (e.g., frusta-shaped, cone-shaped, etc.) extending into the light guide 112 (e.g., formed in an outer surface of the light guide 112). FIG. 15 shows a cross-sectional view showing example implementations of a light extraction element 124 of a light guide 112. In the implementation on the left of FIG. 15, a reflective coating 126 (e.g., a metal, such as aluminum or silver) has been applied above a recess 125 to facilitate reflection of the light that strikes the extraction feature 124 (e.g., if a refractive index difference between material of the light guide 112 and material filling the recess is insufficient to cause light to be redirected). In some implementations, the reflective coating 126 can be omitted, and the light can be turned by the light extraction feature 124 by TIR. In some implementations, the coating 126 can have an index of refraction lower than the index of refraction of the material of the light guide 112, thereby facilitating TIR. For example, the light guide can have an index of refraction of about 1.52. In some implementations, an optical isolation layer (not shown) can be below the light guide 112 and can have an index of refraction of about 1.42 to about 1.47. In some implementations, the coating 126 can have an index or refraction of about 1.42, or of about 1.42 to about 1.47. Materials having other indices of refraction can also be used.

As shown on the right side of FIG. 15, in some implementations, a multilayer stack of different materials can be deposited over the recess 125. The multilayer stack can be an interferometric stack designed to be highly reflective for light that strikes the stack from below (from the light guide 112), and to have low reflectivity for light that strikes the stack from above (e.g., from the direction of the viewer). In some implementations, a reflective layer can be deposited below a black mask or other light blocking layers. In the implementation shown on the right side of FIG. 15, an aluminum layer 129 can be deposited over the recess, a silicon dioxide (SiO₂) layer 131 can be deposited over the aluminum layer 129, and a molybdenum chromium (MoCr) layer 133 can be deposited over the SiO₂ layer 131. Various other configurations are possible. In FIG. 15, the recess 125 is shown with sharp transitions 135, although curved transitions can also be formed in some implementations.

The layers 126, 129, 131, and 133 of FIG. 15 can be deposited by sputtering, chemical vapor deposition, evaporation deposition, and other suitable deposition processes. The layers 126, 129, 131, and 133 can be deposited across the top of the light guide 112 and unwanted portions of the layers 126, 129, 131, and 133 can be removed, for example by photolithography processes. In some implementations, a positive photoresist can be used and unwanted photoresist can be exposed (e.g., to UV light) while the portions of the photoresist to be kept can be masked. In some implementations, a negative photoresist can be used and unwanted photoresist can be masked while the portions of the photoresist to be kept can be exposed (e.g., to UV light). The unwanted portions of the photoresist can be removed using a chemical or developer, followed by reactive ion or other types of etching to remove the unwanted material of the layers 126, 129, 131, or 133 not covered by the remaining photoresist.

As shown in FIG. 14, the light extraction elements 124 can turn the light in the xz-plane so that the light can overcome TIR and exit the light guide. In some implementations, the light extraction elements 124 can have surfaces that are curved or otherwise not aligned with or parallel to the y-axis, so that the light extraction features 124 can change the direction of the light in the y-direction as well as the x and z directions. The extraction features 124 can be configured to scatter light propagating through the light guide 112 in various directions, for example to increase the uniformity of light distribution presented to the display elements 122.

Referring again to FIG. 15, the side walls 127 of the recess 125 can be angled from a line normal to the surface of the light guide 112 by an angle θ₃. The angle θ₃ can be between about 30° and about 60°, between about 40° and about 50°, and the angle θ₃ can be about 40°, about 45°, or about 50°, or the like. The angle θ₃ of the side walls 127 of the light extraction feature 124 can be configured to turn the light out of the light guide 112 with substantially uniform distribution, and the angle θ₃ can depend on the properties of the light guide 112 and on other properties of the illumination system.

Various other types of display elements can be used, such as liquid crystal display (LCD) elements and electrophoretic display elements. FIG. 16 shows another example implementation of a display 128 including an edge light source 100. The display 128 includes transmissive display elements 123 (e.g., LCD). One or more light emitters 102 can emit light to a collimating reflector 104, which can be coupled to a light guide 112. The turning features 124 on the light guide 112 can be similar to those of FIGS. 14 and 15, except that the turning features 124 of FIG. 16 are configured to redirect light upward toward the transmissive display elements 123. In some implementations, the display 128 can include a substrate layer 120, which can be between the light guide 112 and the display elements 123. In some implementations, the substrate 120 can be used for forming other layers (e.g., layers of the display elements 123, diffusers, color filters, black masks, etc.). In some implementations, the light guide 112 can be used as a substrate for forming other layers (e.g., layers of the display elements 123, diffusers, color filters, black masks, etc.). In certain such implementations, the substrate layer 120 can be omitted. The display 128 can include other layers and features (e.g., a diffuser positioned between the light guide 112 and the display elements 123, a cladding layer, a protective top-coat, pressure sensitive adhesives, a touch sensitive panel, etc.), but are not illustrated in FIG. 16 for simplicity. The light emitters 102, reflector 104, and light guide 112 can function as a back light for the transmissive display 128 (e.g., as illustrated in FIG. 16) or a front light for the reflective display 118 (e.g., as illustrated in FIG. 14). In some implementations, the light emitters 102, reflector 104, and light guide 112 can function as a back light for a reflective display or a front light for a transmissive display, for example by using reflectors or other optical features to redirect light propagating out of the light guide 112.

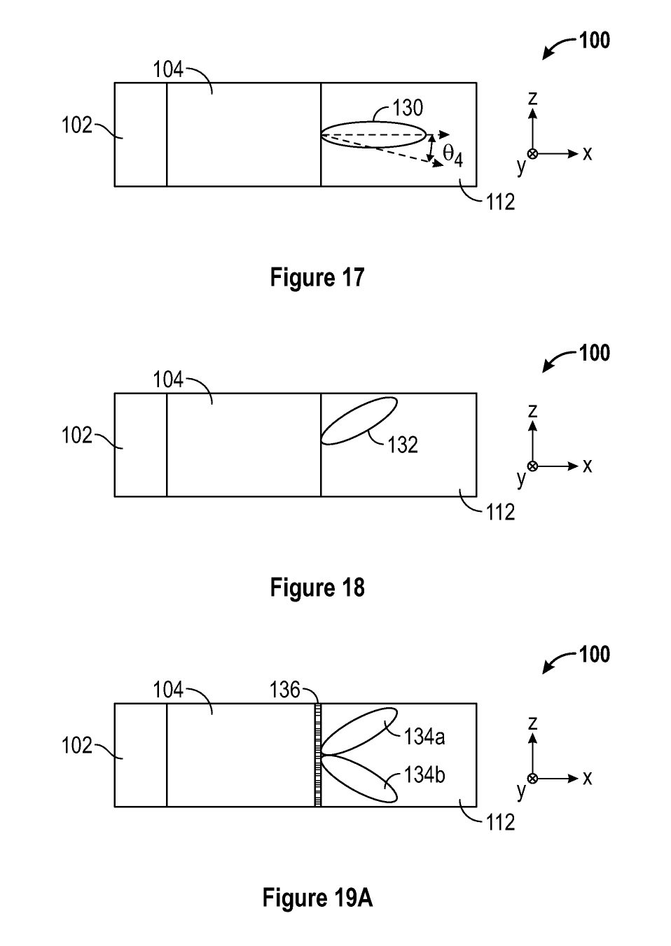

Adjustment of the upper reflector portion 104a and/or of the lower reflector portion 104b and/or addition of an optical element can alter the light output from the reflector 104. In some implementations, the light emission distribution from the reflector 104 can be centered on an angle that is offset from the x-axis. In some implementations, the light exiting the reflector 104 can be represented as axial lobes, skewed lobes, and/or multi-lobes. FIG. 17 schematically shows a side view of an example implementation of an edge light source producing an axial lobe 130. The lobe 130 includes light directed in generally the x-direction. The lobe 130 is a representation of the amount of light that propagates from the reflector 104 into the light guide 112 at various directions in the xz-plane. The major axis of the ellipse-shaped lobe 130, which in FIG. 17 is substantially parallel with the x-axis, represents the direction of peak intensity of light exiting the reflector 104. The curved line of the lobe 130 represents the intensity of light output from the reflector 104 at the various angles that intersect the curved line. For example, as shown in FIG. 17, a line that is offset from the major axis by an angle θ₄ intersects the curved line at a point that is halfway between ends of the lobe 130, representing that the full-width-half-maximum (FWHM) angle for the light output by the reflector in FIG. 17 is ±₄. The full-width-half-maximum (FWHM) angle for the light represented by the lobe 130 can be at least about ±10° and/or less than or equal to about ±35°, or about ±25°. The lobe 130 can represent light distribution having a gradual fade in the xz-plane, rather than a sharp cutoff.

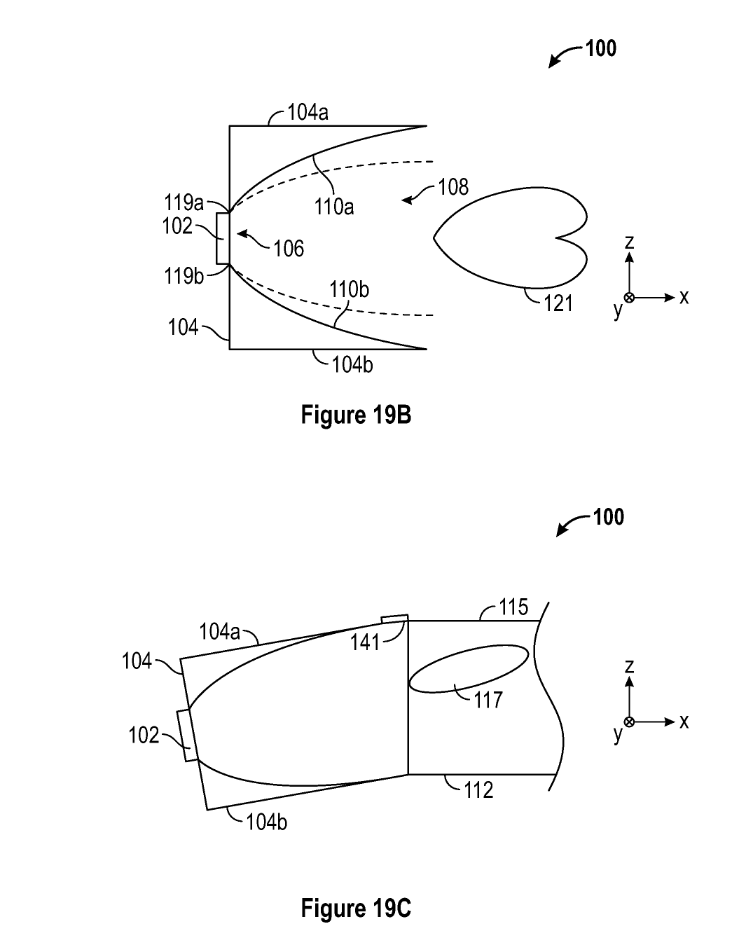

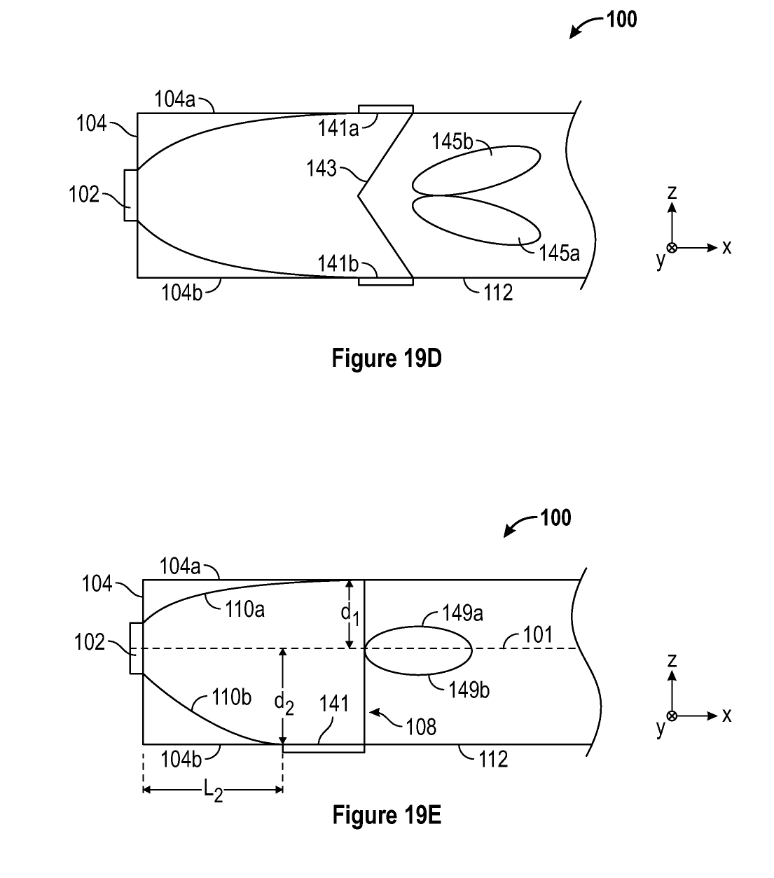

FIG. 18 schematically shows side an example implementation of an edge light source producing a skewed lobe 132. The skewed lobe 132 can be of similar shape as the lobe 130 of FIG. 17, but is offset from the x-axis by less than about 55°, less than about 45°, less than about 35°, between about 5° and 45°, or between about 15° and 35°, and in some implementations, the offset can be about 15°. One or both of the upper reflector portion 104a and the lower reflector portion 104b, as well as the light emitter 102, can be asymmetric, offset, shaped, and/or angled to produce the skewed lobe 132. FIG. 19A schematically shows a side view of an example implementation of an edge light source producing multiple lobes 134a and 134b. Both of the upper reflector portion 104a and the lower reflector portion 104b, as well as the light emitter 102, can be asymmetric, offset, shaped, and/or angled to produce the multiple lobes 134a and 134b. In some implementations, a holographic film 136 can be positioned between the reflector 104 and the light guide 112 so that the light entering the light guide 112 passes through a diffraction pattern that modifies the emission distribution of the light. The holographic film 136 can be configured to produce various types of emission distributions of light. In the implementation shown in FIG. 19A, the emission distribution of light is represented by two lobes 134a and 134b, which are offset from the x-axis in opposite directions by less than about 55°, less than about 45°, less than about 35°, between about 5° and 45°, or between about 15° and 35°, and in some implementations, the offset can be about 15°. The skewed light distribution can direct the light output from the reflector 104 in an angled direction according to the particular implementation being used. For example, the light guide 112 may extend from the reflector 104 at an angle offset from the x-axis, and skewing the light output from the reflector 104 can facilitate guiding of the light in the angled light guide 112.

FIG. 19B shows a cross-sectional view of an example implementation of an edge light source 100 including rotated upper and lower reflector portions 104a and 104b. In FIG. 19B, the dotted lines show an example implementation of a reflector shape that can produce a single axial lobe of light (e.g., the lobe 130 of FIG. 17). As shown in FIG. 19B, one or both of the shaped reflective surfaces 110a and 110b can be rotated with respect to the shape that produces a single axial lobe, thereby modifying the output of light (e.g., to produce a multi-lobed output 121 of light, which can be similar to the light of multiple lobes 134a and 134b discussed above). The upper shaped reflective surface 110a can be rotated about an axis 119a (e.g., parallel or substantially parallel to the y-axis), which can be at or near the upper end of the input aperture 106. The lower shaped reflective surface 110b can be rotated about an axis 119b (e.g., parallel or substantially parallel to the y-axis), which can be at or near the lower end of the input aperture 106. In some implementations, rotating the shaped reflective surfaces 110a and 110b can change the size of the output aperture 108, and can leave the size of the input aperture 106 substantially unchanged. The upper shaped reflective surface 110a can be rotated away from (or towards, in some implementations) the lower shaped reflective surface 110b by at least about 1°, by at least about 5°, or by at least about 10°, although values outside these ranges can also be used. For example, rotation of the upper shaped reflective surface 110a by larger amounts (e.g., by at least about 15°, or by at least about 30°) are possible, but in some cases can bring about optical deviations, which may be undesirable for certain applications. The lower shaped reflective surface 110b can be rotated away from (or towards, in some implementations) the upper shaped reflective surface 110a by at least about 1°, by at least about 5°, by at least about 10°, although values outside these ranges can also be used (e.g., rotation of at least about 15°, or at least about 30°, as discussed above). In some implementations, smaller angles of rotation can produce less optical deviations.

FIG. 19C shows a cross-sectional view of an example implementation of an edge light source 100 including a tilted light emitter 102 and reflector 104. The light emitter 102 and reflector portions 104a and 104b can be angled (e.g., about an axis parallel or substantially parallel to the y-axis) with respect to the light guide 112 by at least about 1°, by at least about 5°, or by at least about 10°, although values outside these ranges can also be used. The tilted reflector portions 104a and 104b can produce a skewed lobe 117 of light, which can be similar to the skewed lobe 132 discussed above. The skewed lobe 117 can be directed at an angle relative to the light guide 112 (e.g., relative to the output surface 115 of the light guide 112), for example, by at least about 1°, by at least about 5°, by at least about 10°, by at least about 15°, or by at least about 30°, although values outside these ranges can also be used. In some implementations, one of the reflector portions 104a can be separated from the light guide 112 due to the tilted orientation of the reflector portions 104a and 104b, and an extension 141 can be positioned between the reflector portion 104a and the light guide 112. The extension 141 can have, for example, an inward facing planar reflective surface to facilitate coupling light into the light guide 112. In some implementations, the reflector portion 104a can have a shape different than the shape of the reflector portion 104b, so that both reflector portions 104a contact the light guide 112 (e.g., without an extension 141).

FIG. 19D shows a cross-sectional view of an example implementation of an edge light source 100 including a reflector that includes a prismatic trough 143. The prismatic trough 143 is configured to refract light as it enters the light guide 112, thereby redirecting the light as shown symbolically as lobes 145a and 145b of FIG. 19D. In some implementations, the prismatic trough 143 can produce multiple lobes 145a and 145b of light. For example, light refracted by an upper surface of the prismatic trough 143 can form a first lobe 145a of light (e.g., which can be angled downward), and light refracted by a lower surface of the prismatic trough 143 can be configured to form a second lobe 145b of light (e.g., which can be angled upward). In some implementations, an extension 141a can be positioned between the upper reflector portion 104a and the light guide 112, and an extension 141b can be positioned between the lower reflector portion 104a and the light guide 112. The extensions 141a and 141b can have inwardly facing planar reflective surfaces to facilitate coupling light into the light guide 112. In some implementations, at least a portion of the prismatic trough 143 can extend into the space between the reflector portions 104a and 104b, so that the reflector portions can contact the light guide 112 (e.g., without extensions 141a and 141b).

FIG. 19E shows a cross-sectional view of an example implementation of an edge light source 100 including an asymmetric reflector 104. The upper shaped reflective surface 110a can have a first shape (which can be configured to substantially preserve etendue, as discussed herein) and the lower shaped reflective surface 110b can have a second shape, different from and asymmetric to the first shape (which can also be configured to substantially preserve etendue, as discussed herein). The reflector 104 can produce light output including a lobe of light having an upper portion 149a and a lower portion 149b. The lower reflector portion 104b can contribute to the upper portion 149a of the lobe of light more than the upper reflector portion 104a, and the upper reflector portion 104a can contribute to the lower portion 149b of the lobe of light more than the lower reflector portion 104b. In some implementations, the distance d₁ between the end of the upper reflector portion 104a and the optical axis 101 of the reflector 104 can be less than the distance d₂ between the end of the lower reflector portion 104b and the optical axis 101 of the reflector 104. The lobe of light can have a lower portion 149b than is wider (in the z-direction) than the upper portion 149a. In some cases, the upper reflector portion 104a can have a length L₁ (e.g., in the x-direction) that is longer than a length L₂ of the lower reflector portion 104b. The upper reflector portion 104a can provide more collimation (in the xz-plane) than the lower reflector portion 104b. In some implementations, an extension 141 can be positioned between the lower reflector portion 104b and the light guide 112. The extension 141 can have, for example, an inward facing planar reflective surface to facilitate coupling substantially all output light into the light guide 112. Various other shapes of asymmetrical shaped reflector surfaces 110a and 110b can be used to produce a variety of optical outputs. For example, the reflector portions 104a and 104b can have substantially similar lengths L₁ and L₂ and different distances d₁ and d₂, or substantially similar distances d₁ and d₂ and different lengths L₁ and L₂. Also, in some implementations, the lower reflector portion 104b can have a shorter distance d₂ and/or a longer length L₂ than the distance d₁ and length L₁ of the upper reflector portion 104a. Many other configurations are possible. In each configuration, the reflector 104 design may reduce (e.g., minimize) the amount of light from the upper reflector portion 104a hitting the lower reflector portion 104b, and vice versa.

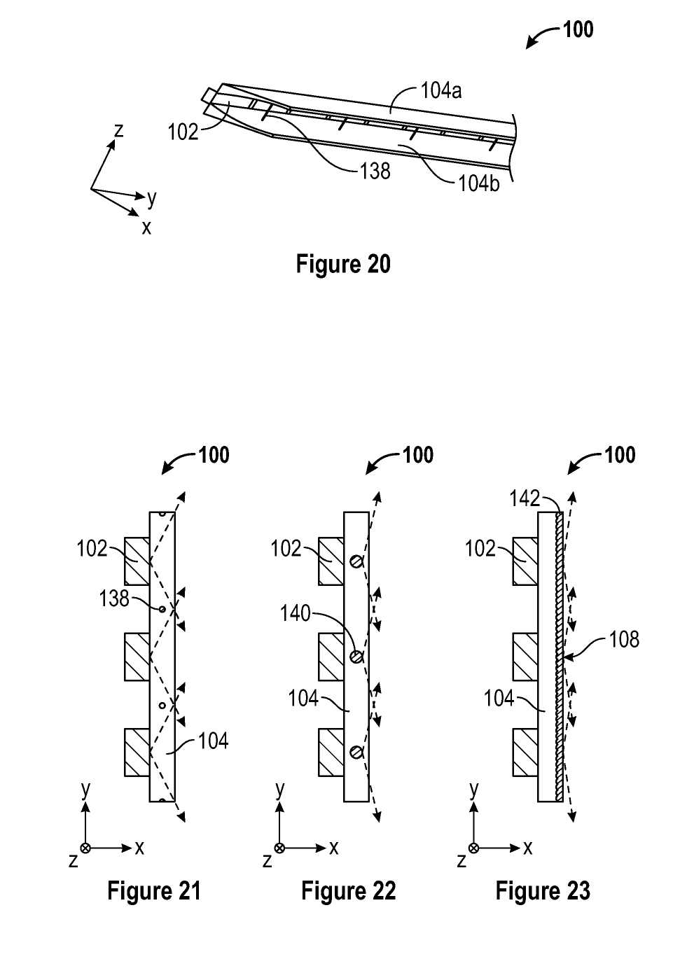

FIG. 20 shows a perspective view of an edge light source 100 including vertical stabilizers 138. The edge light source 100 includes one or more vertical stabilizers 138 between the upper reflector portion 104a and the lower reflector portion 104b. Vertical stabilizers 138 can be configured to maintain the spacing between the upper reflector portion 104a and the lower reflector portion 104b, for example, by inhibiting or preventing the upper reflector portion 104a and the lower reflector portion 104b from collapsing towards each other. In some implementations, the vertical stabilizers 138 can be posts dispersed along the length of the reflector 104, for example as shown in FIG. 20. In some implementations, the stabilizers 138 can include posts made of transparent plastic, such as, as one example, acrylic. The stabilizers 138 may be injection-molded with one or more parts of the reflector 104, such as the upper reflector portion 104a and/or the lower reflector portion 104b.

FIG. 21 shows a cross-sectional view in an xy-plane of an edge light source 100 including posts for vertical stabilizers 138. The z dimension is in and out of the page. The stabilizers 138 can be positioned at locations configured to reduce or minimize the effect of the stabilizers 138 on the distribution of light output from the reflector 104. For example, as can be seen in FIG. 21, the stabilizers 138 can be positioned between the light emitters 102 along the y-axis, or at areas of intersection for adjacent light emitters 102. Most of the light emitted by the light emitters 102 can propagate out of the reflector 104 without substantially being affected by the stabilizers 138. For light emitters 102 having a Lambertian distribution, some light will propagate outside of the FWHM lines drawn in FIG. 21, so some light may strike the stabilizers 138, which can affect the light distribution to a small degree. Because the amount of light propagating outside the FWHM distribution area is small, and/or because the stabilizers 138 can have a small profile causing only a small portion of the light to strike the stabilizers 138, and/or because the stabilizers 138 can be positioned so that the light striking the stabilizers 138 is propagating in a direction that is far off axis in the xy-plane and is not useful for illuminating a display, the light can exit the reflector 104 substantially unaffected by the stabilizers 138.

In some implementations, an optical element can be positioned between the reflector 104 and the light guide 112, and the optical element can be used to modify the light distribution exiting the reflector 104. As described herein, for example in connection with FIG. 19A, a holographic film can be used to modify the distribution of light. FIG. 22 shows a cross-sectional view in an xy-plane of an edge light source including pillar lenses 140. The z dimension is in and out of the page. One or more lenses 140 can be positioned generally in front of corresponding light emitters 102 so that light emitted by the light emitters 102 can be modified by the lenses 140. In some implementations, the lenses 140 can be pillar lenses that extend between the upper reflector portion 104a (e.g., FIG. 20) of the reflector 104 and the lower reflector portion 104b (e.g., FIG. 20) of the reflector 104 to act as vertical stabilizers for maintaining the spacing between the reflector portions 104a and 104b. The lenses 140 can be cylindrical lenses configured to operate on light in the xy-plane with a higher optical power than on light in the xz-plane. The lenses 140 can increase the divergence of light propagating in the xy-plane, which can increase uniformity of illumination in a display, as discussed herein. In some implementations, the lenses 140 can have substantially no optical power in the xz-plane, so that the lenses 140 have substantially no affect on the distribution of the partially collimated light propagating in the xz-plane.

FIG. 23 shows a cross-sectional view in an xy-plane of an edge light source 100 including a lenticular film 142. The z dimension is in and out of the page. The lenticular film 142 is positioned to modify the light distribution of the light exiting the reflector 104. The lenticular film 142 can include multiple lenticular elements dispersed along the y-axis to receive light emitted from the light emitters 102 and/or reflected by the reflector 104. In the implementation illustrated in FIG. 23, a single lenticular film 142 is shown that extends across substantially the entire length of the edge light source 100 along the y-axis. In some implementations, multiple lenticular films can be used, for example with gaps therebetween. The lenticular film 142 can extend from the upper reflector portion 104a (e.g., FIG. 20) of the reflector 104 to the lower reflector portion 104b (e.g., FIG. 20) of the reflector 104 so that the lenticular film 142 also acts as a vertical stabilizer to maintain the spacing between the upper reflector portion 104a to the lower reflector portion 104b. The lenticular elements can have optical power in the xy-plane so that the combined lenticular elements of the lenticular film can operate to scatter light propagating in the xy-plane, thereby increasing the divergence of light in the xy-plane, which can increase uniformity of illumination for a display, as discussed herein. In some implementations, the lenticular elements have substantially no optical power in the xz-plane, so that the lenticular film 142 has substantially no affect on the distribution of the at least partially collimated light propagating in the xz-plane.

The lenticular film 142 can be positioned adjacent or near the output aperture 108 of the reflector 104, for example as shown in FIG. 23. In some implementations, the lenticular film 142 can be optically coupled to the input of a light guide 112 (e.g., FIG. 20) so that light propagates from the lenticular film 142 directly into the light guide 112 (e.g., through an adhesive or refractive index matching material). In some implementations, the lenticular film 142 can be spaced apart from the output aperture 108 and/or spaced apart from the light guide 112 so that an air gap is formed between the lenticular film 142 and a light guide 112. In some implementations, the lenticular film 142 can operate with optical power on the light in the xy-plane as the light enters the lenticular film 142, as well as when the light exits the lenticular film 142. Although not shown, in some implementations, a diffusive film (e.g., having an irregular diffusive surface) can be used in place of the lenticular film 142. In some alternative implementations, other scattering features can be used instead.

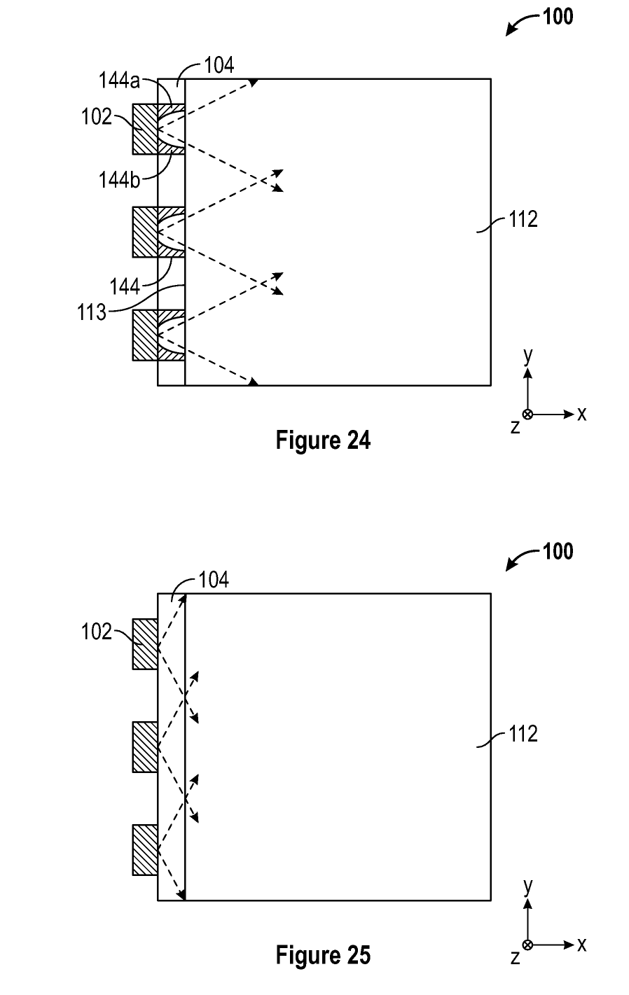

FIG. 24 shows a cross-sectional view in an xy-plane of an example edge light source 100 including additional collimating elements 144 and light directed into a light guide 112. The z dimension is in and out of the page. Light from the light emitters 102 can be at least partially collimated in the xz-plane by the reflector 104, for example as discussed with respect to various other implementations herein. One or more additional collimating members 144 can be configured to at least partially collimate light propagating in the xy-plane. In some implementations, a right or first reflector portion 144a can be positioned on a first side of a light emitter 102, and a left or second reflector portion 144b can be positioned on a second side of the light emitter 102, for example as shown in FIG. 24. The reflector portions 144a and 144b can include mathematically or otherwise shaped reflective surfaces similar to 110a and 110b of FIG. 10, for example, except that the reflector portions 144a and 144b are configured to at least partially collimate light in the xy-plane. The reflector portions 144a and 144b can extend between the upper reflector portion 104a and the lower reflector portion 104b to act as a vertical stabilizer.

FIG. 24 shows light entering the light guide 112 that is partially collimated from Lambertian distribution (e.g., by the reflectors 144a and 144b) in the xy-plane. The narrow angle of distribution in the xy-plane can reduce uniformity of light in the light guide 112, especially near the input to the light guide 112. As can be seen in FIG. 24, collimation in the xy-plane can cause triangular bright and dark regions near the light guide 112 input. Collimation in the xy-plane can also cause a crosshatching appearance in the light guide. The uneven distribution of light in the light guide 112 can result in uneven output of light from the light guide 112 (e.g., light turned by the extraction elements 124) and uneven illumination of a display including the edge light source 100, thereby reducing image quality.

In some implementations, the input surface (or entrance aperture) 113 of the light guide 112 can have an irregular surface for diffusing light that enters the light guide 112. For example, the input surface of the light guide 112 can be ground to produce the irregular surface. The diffusion of the light entering the light guide 112 by the irregular surface can reduce the crosshatching and the triangular irregularities in the light guide 112 to some extent. However, diffusion of the light entering the light guide 112 can cause some of the light to be redirected to an angle that overcomes TIR, allowing such light to escape the light guide 112 without being turned. A diffusive surface on the input surface 113 of the light guide 112 can reduce the overall brightness of the display and/or can create an irregular bright area where the diffuser redirects a portion of the light out of the light guide 112.

FIG. 25 shows a cross-sectional view in an xy-plane of an example implementation of an edge light source 100 and light directed into a light guide 112. The z dimension is in and out of the page. The edge light source 100 does not collimate light in the xy-plane. Light in the xy-plane can be input into the light guide 112 having the same distribution of the light as defined by the light emitters 102 (e.g., Lambertian distribution). Most of the light in the xy-plane can be within the FWHM lines (e.g., about ±60° for Lambertian distribution), for example as shown in FIG. 25. As can be seen in FIG. 25, the light in the xy-plane is more evenly distributed in the light guide 112, as compared to the partially collimated implementation of FIG. 24, especially near the input surface 113 of the light guide 112. In some implementations, the divergence of light entering the light guide 112 can be increased (e.g., by scattering, diffraction, optical power, etc.) using one or more optical elements, such as a lenticular film (e.g., the lenticular film 142 described herein with respect to FIG. 23), lenses (e.g., the lenses 140 described herein with respect to FIG. 22), a holographic film (e.g., the holographic film 136 described herein with respect to FIG. 19A), a diffuser, combinations thereof, and the like. In some implementations, a lenticular film 142 can be used to increase divergence of light in the xy-plane, and not substantially affect the light in the xz-plane, to improve uniform distribution of light in the xy-plane while allowing the light in the xz-plane to remain partially collimated by the reflector 104.

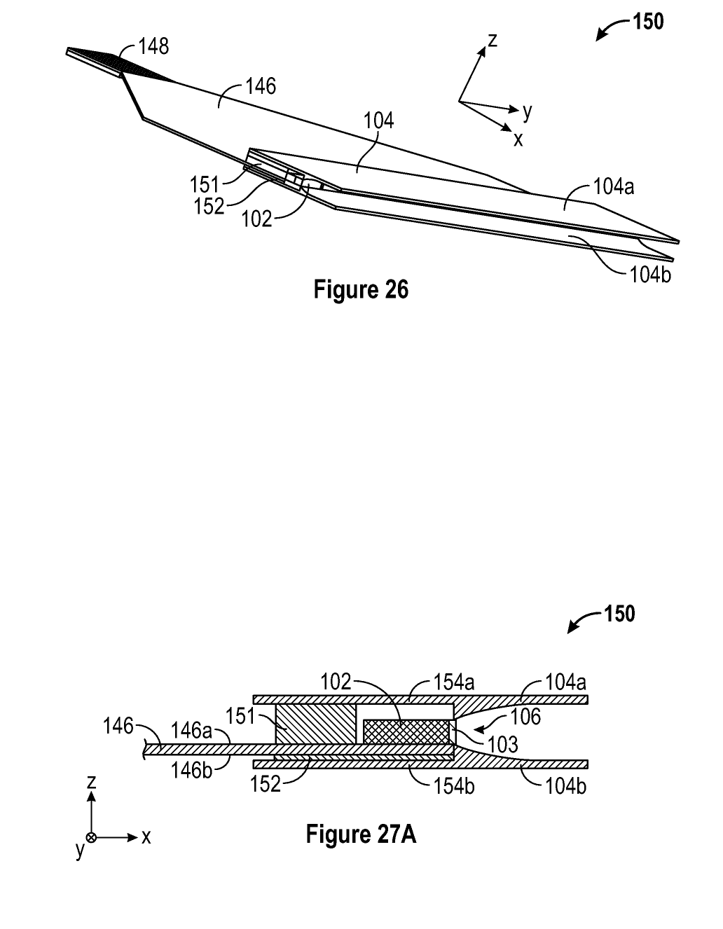

FIG. 26 shows a perspective view of an example implementation of a flexible circuit edge light source 150. The system 150 can include light emitters 102, an upper reflector portion 104a, and a lower reflector portion 104b, for example similar to various other implementations discussed herein. The system 150 can also include other features described herein (e.g., a lenticular film, lenses, a holographic film a diffuser, combinations thereof, vertical stabilizers, engagement features, and the like). A flexible electrical interconnection circuit 146 can be used to incorporate the edge light source 150 into an electronic device, such as a display. The flexible electrical interconnection circuit 146 can include surface mounted electrical pathways (e.g., wires) for electronically connecting the light emitters 102 to a power source (not shown). In some implementations, the flexible electrical interconnection circuit 146 can include a zero insertion force (ZIF) termination 148, for example at an end opposite the light emitters 102, although other locations are also possible. The ZIF termination 148 can be configured to couple with a receiver portion on an electronic device to provide power and/or signals to the light emitters 102 via the flexible electrical interconnection circuit 146. In some implementations, other components of the electronic device (e.g., processors, memory devices, integrated circuits) can be coupled to and/or integrated into the flexible electrical interconnection circuit 146. Because the electrical interconnection circuit 146 is flexible, the system 150 can be oriented at various different positions depending on the size and parameters of the electronic device. In some implementations, the flexible electrical interconnection circuit 146 can conform to the general shape of the housing of the electronic device or to other components of the electronic device that are positioned adjacent to the flexible electrical interconnection circuit 146. The flexible electrical interconnection circuit 146 can fit into compact and/or irregular spaces, for example to facilitate the production and/or form factor of compact electronic devices. Because the flexible electrical interconnection circuit 146 can be repositioned to various different orientations, a single type of flexible circuit edge light source 150 can be compatible with various different designs of electronic devices, thereby reducing the cost and complexity of producing the electronic devices.

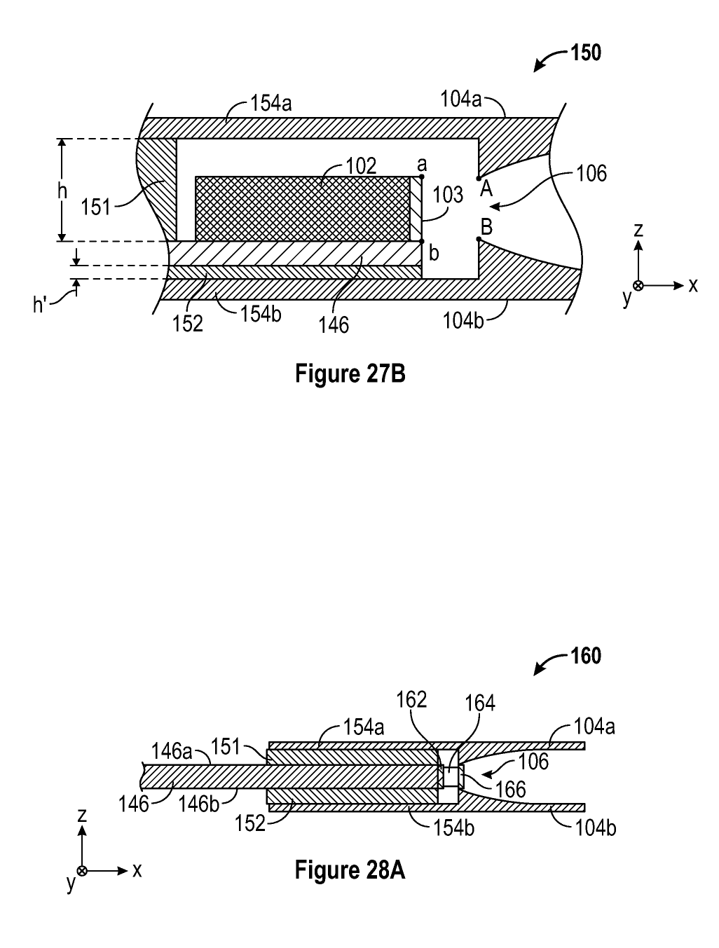

FIG. 27A shows a cross-sectional view of the flexible circuit edge light source 150 of FIG. 26 taken through a light emitter 102 in the xz-plane of FIG. 26. FIG. 27B shows a detailed cross-sectional view of light emitter 102 and reflector portions 104a and 104b of the flexible circuit edge light source 150 of FIG. 26 taken in the xz-plane. The flexible electrical interconnection circuit 146 can include the light emitter 102 mounted onto a first side (e.g., top) thereof. As described herein, various different types of light emitters 102 can be used, such as an LED chip, an LED with a phosphor layer, and an OLED. The light emitters 102 can be surface-emitting light emitters configured to emit light from a surface 103, which can be, for example, a phosphor layer or the surface of an LED chip. The electrical interconnection circuit 146 can be flexible. For example, flexible materials can be used and/or the layers can be formed thin enough to allow bending of the flexible electrical interconnection circuit 146.

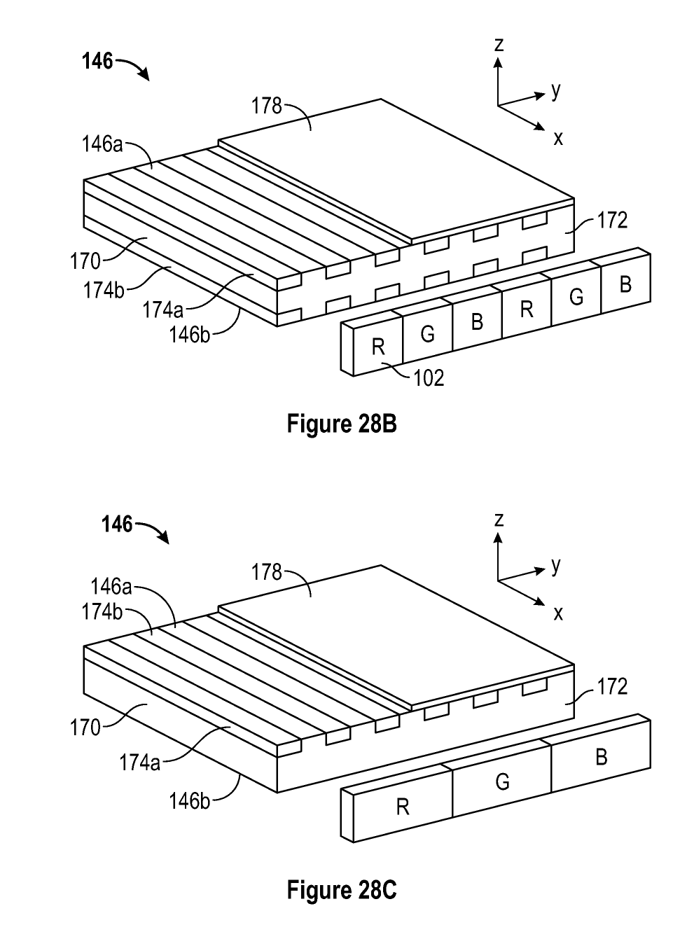

FIG. 28A shows a cross-sectional view in an xz-plane of another example implementation of a flexible circuit edge light source 160. The y dimension is in and out of the page. In the system 160, the LEDs 162 are mounted onto an edge surface of the flexible electrical interconnection circuit 146. In some implementations, a blue LED 162 can be used (e.g., a Citizen CL-435S LED) with a yellow or yellow-green phosphor 166 to produce generally white light. The phosphor 166 can be positioned adjacent or near the input aperture 106 of the reflector 104 and can be configured to substantially fill the input aperture 106. In some implementations, a light guide 164 can be positioned between the LED 162 and the phosphor layer 166. The light guide 164 can be configured, for example, to guide light by total internal reflection (TIR) from the LED 162 to the phosphor 166. In some implementations, the LEDs 162, the light guide 164 and the phosphor 166 can be provided in a single package. Various other light emitters can be used. For example, in some implementations, a mixed array of red, green, and blue LEDs can be used to produce generally white light. For another example, in some implementations, other combinations of LED and phosphor colors can be used to produce generally white light. For yet another example, in some implementations, other LEDs and/or phosphors can be used to produce non-white light.

Referring to FIGS. 26-28A, the upper reflector portion 104a can include an arm 154a extending over a portion of the flexible electrical interconnection circuit 146, and the lower reflector portion 104b can include an arm 154b extending under a portion of the flexible electrical interconnection circuit 146. Once assembled, a gap can be formed between the upper arm 154a and the lower arm 154b, and the flexible electrical interconnection circuit 146 can extend into the gap. One or more spacer layers can be positioned on the flexible electrical interconnection circuit 146, between the upper arm 154a and the lower arm 154b to precisely space the upper reflector 104a from the lower reflector 104b by a distance (e.g., by the distance configured to set the input aperture 106 and the output aperture 108 to the widths specified by Sine Law for the dimensions of the particular implementation) and/or to position the light emitter 102 at the input aperture 106. At least one upper spacer 151 can be positioned above the flexible electrical interconnection circuit 146, and at least one spacer 152 can be positioned below the flexible electrical interconnection circuit 146. The spacers 151 and 152 can be electrically insulating layers, and can be made from one or more layers of a polymer material, such as polyimide. In some implementations, the arms 154a and 154b can be adhered to the spacers 151 and 152 using adhesive layers.

The thicknesses of the spacers 151 and 152 may vary in different implementations to accommodate the light emitter 102. For example, in FIGS. 27A and 27B, the upper spacer 151 can have a thickness h that is greater than the thickness h′ of the lower spacer 152 (e.g., to account for a thickness and/or positioning of the light emitter 102), and the flexible electrical interconnection circuit 146 can be positioned generally below the input aperture 106. The light emitter 102 mounted onto the top of the flexible electrical interconnection circuit 146 can be positioned with an output surface 103 adjacent to or near the input aperture 106 of the reflector 104. The spacers 151 and 152, the light emitter 102, the flexible electrical interconnection circuit 146, and the reflector portions 104a and 104b can be configured to position the light emitting surface 103 and the boundaries a and b of light emitting aperture of the light emitter 102 adjacent or near the input aperture 106 of the reflector 104. For example, the boundaries a and b of the light emitting aperture of the light emitter 102 can be positioned coplanar or substantially coplanar (e.g., in the xy-plane of FIG. 27B) with the reflector's upper and lower entrance aperture points A and B, respectively. Although FIG. 27B shows the input aperture 106 of the reflector offset from the output surface 103 of the light emitter 102, the light emitting aperture of the light emitter 102 can be adjacent or near the input aperture 106, as shown in FIG. 27A and as discussed herein. The light emitting surface 103 and its effective light emitting aperture bounded by points a and b can substantially fill input aperture 106 of the reflector portions 104a and 104b in the z-direction. In some implementations, the upper spacer 151 can be taller than the light emitter 102 so that the upper reflector 104a is positioned high enough that the bounding point a on the light emitting surface 103 of the light emitter 102 is positioned adjacent or near the corresponding boundary point A on input aperture 106, thereby forming a gap above the light emitter 102, as shown in FIG. 27A. Many other configurations are possible for positioning the light emitting surface 103 adjacent or near the input aperture 106, e.g., in a way that substantially maximizes the efficiency with which light from the light emitter 102 is transferred through the reflector's input aperture 106 and its two extreme boundaries, points A and B. For example, in some implementations, the light emitter 102 (or packaging thereof) can had a height that is the same or substantially the same as the upper spacer 151, thereby reducing or eliminating the gap above the light emitter 102 shown in FIG. 27A. In another example illustrated in FIG. 28A, the upper spacer 151 can have generally the same thickness as the lower spacer 152 such that the end of the flexible electrical interconnection circuit 146 can be positioned by the spacers 151 and 152 at a location generally midway between the arms 154a and 154b and such that the light emitter 102 positioned at the end of the flexible electrical interconnection circuit 146 can be adjacent to or near the input aperture 106 of the reflector 104. Note that in the implementation illustrated in FIG. 28A, the spacers 151 and 152 do not extend all the way to or near the input aperture 106 of the reflector 104 such that some space is provided to accommodate LEDs 162 that are thicker than the flexible electrical interconnection circuit 146.

To assemble the edge light sources 150 and 160 of FIGS. 27A and 28A, the flexible electrical interconnection circuit 146 can be provided, and the light emitter 102 can be mounted thereon. The spacers 151 and 152 can be applied to the first and second sides of the flexible electrical interconnection circuit 146, and the reflector portions 104a and 104b can be applied with the arms 154a and 154b positioned over and under the spacers 151 and 152, so that the thickness of the flexible electrical interconnection circuit 146 and the spacers 151 and 152 at least partially determine the spacing between the reflector portions 104a and 104b (e.g., possible along with the thickness of the arms 154a and 154b and the presence of any additional layers, adhesives, etc.). Note that the thicknesses of the spacers 151 and 152 can be designed to provide spacing for the reflector portions 104a and 104b that conforms with Sine Law, as discussed herein.

FIG. 28B shows an exploded view of a portion of an example implementation of a flexible electrical interconnection circuit 146. The electrical interconnection circuit 146 can have light emitters 102 mounted onto the end thereof, similar to the implementation shown in FIG. 28A. The flexible electrical interconnection circuit 146 can include a base material layer 170, which can include a polymer material, such as polyimide. Conductor portions 174a and 174b can be formed on the base layer 170, e.g., using stamping, lift-off patterning, lithography, and the like. The conductor portions 174a and 174b can include a metal (e.g., copper) or other conducting materials. The conductor portions 174a and 174b can extend along the electrical interconnection circuit 146 (e.g., as surface mounted electrical pathways in the electrical interconnection circuit 146) and can be configured to carry electrical power and/or signals to the light emitters 102. The base material 170 can be an insulator material that separates the conductor portions 174a and 174b from each other. In some implementations, a coverlay layer 178 can be disposed over the conductor portions 174a and 174b. Although the coverlay layer 178 is shown only on the right and top sides of FIG. 28B, the coverlay layer 178 can extend across the entire (or substantially the entire) top surface of the flexible electrical interconnection circuit 146, for example, to insulate the conductor portions 174a from unintentional contact with other components. The coverlay layer 178 can be made of an insulating material, such as a polymer material (e.g., polyimide). In some implementations, the bottom surface of the flexible electrical interconnection circuit 146 can also include a coverlay layer 178 to insulate the conductor portions 174b from unintentional contact with other components.

The conductor portions 174a and 174b can be exposed on an end face 172 of the flexible electrical interconnection circuit 146. In some implementations, the end face 172 can be planar or substantially planar, so that the light emitters 102 can be coupled to the end face 172 of the flexible electrical interconnection circuit 146. The light emitters 102 (e.g., LEDs) can be coupled electrically and physically to the flexible electrical interconnection circuit 146 by means of reflow soldering or any other suitable electrical and physical attachment manner. In some implementations, multiple conductor portions 174a and 174b can connect to a single light emitter 102. For example, a first conductor portion 174a can be a positive terminal and can provide an electrical connection, for example, to an anode of an LED light emitter 102. A second conductor portion 174b can be a negative terminal and can provide an electrical connection, for example, to a cathode of the LED light emitter 102. In some implementations, the first conductor portions 174a can be on a first side 146a of the flexible electrical interconnection circuit and the second conductor portions 174b can be on a second side 146b of the flexible electrical interconnection circuit, as shown in FIG. 28B. In some implementations, the first and second conductor portions can both be positioned on the first side 146a of the flexible electrical interconnection circuit 146, which can simplify construction of the flexible electrical interconnection circuit 146. FIG. 28C is an exploded view of a portion of an example implementation of a flexible electrical interconnection circuit 146. The flexible electrical interconnection circuit 146 of FIG. 28C includes conductor portions 174a and 174b both on one side 164a of the flexible electrical interconnection circuit 146. The first conductor portion 174a can be a positive terminal and can provide an electrical connection, for example, to an anode of an LED light emitter 102, and the second conductor portion 174b can be a negative terminal and can provide an electrical connection, for example, to a cathode of the LED light emitter 102.

In various implementations disclosed herein, light emitters 102 of different colors can be used, which can combine to produce white light, substantially white light, or other colors as appropriate. For example, as shown in FIG. 28B, red R, green G, and blue B, light emitters 102 (e.g., LEDs) can be arranged sequentially along the y-direction so that light from the LEDs combines to produce white light or substantially white light. The light emitters 102 can be surface emitting LED chips having generally square or rectangular shaped output surfaces, which can be about 0.2 mm by about 0.2 mm in size. The reflector 104 can have an input aperture height in the z-axis of about 0.2 mm and an output aperture height of about 0.5 mm (or about 0.2 mm, or any height between about 0.2 mm and about 0.6 mm), also in the z-direction. The light guide 112 can have a thickness of about 0.5 mm. The light emitters 102 can direct light to phosphors 166 in FIG. 28A or into one or more light guides 164, as shown in FIG. 28B. In some implementations, the light emitters 102 can be end-mounted onto the flexible electrical interconnection circuit and can be positioned at or near the input aperture 106 of the reflector 104 to directly illuminate the reflector 104. Although the light emitters 102 are shown abutting each other in FIG. 28B, in some implementations, the light emitters 102 can be spaced apart so that small but reasonable gaps are formed between the light emitters 102 in the y-direction allowing for interconnection means as may be required.

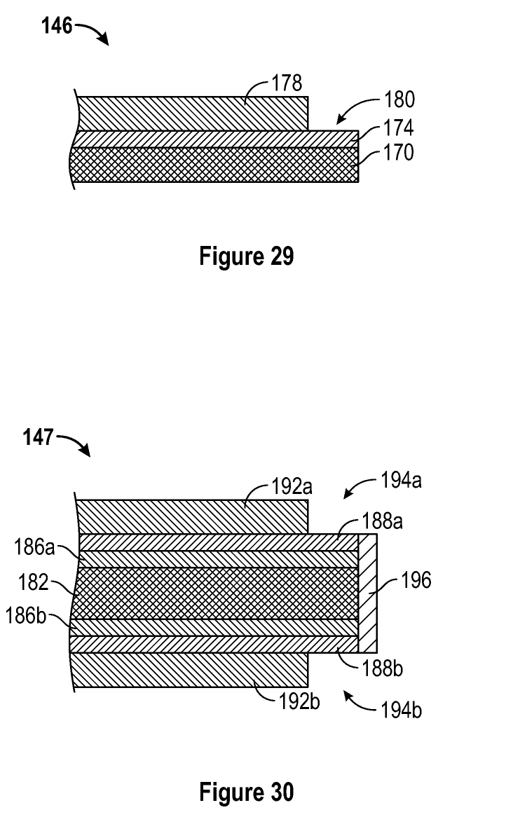

FIG. 29 shows a cross-sectional view of a portion of an example implementation of a flexible electrical interconnection circuit 146. In some implementations, the flexible electrical interconnection circuit 146 can include a base material layer 170, which can include a polymer material, such as polyimide. A conductor layer 174 (e.g., including copper) can be formed on the base layer 170, e.g., using stamping, lift-off patterning, lithography, and the like. The electrical interconnection circuit 146 can include a coverlay layer 178 that covers at least a portion of the conductor layer 174. The coverlay layer 178 can include a polymer material, such as polyimide, and can be coupled to the conductor layer 174 by an adhesive layer (not shown for simplicity). Connection points 180 may be devoid of the coverlay layer 178 so that a light emitter 102, or other component, can be electrically coupled to the conductor 174, which may include, for example bond pads in the area of the connection points 180. Although only a single conductive layer 174 is shown in FIG. 29, the flexible electrical interconnection circuit 146 can include multiple layers of conductive layers spaced by coverlay or insulating layers, and possibly including vias or interconnects between the layers, formed bottom up (e.g., as shown in FIG. 29) or formed on each side of a base material layer.

FIG. 30 shows a cross-sectional view of a portion of another example implementation of a flexible electrical interconnection circuit 147. The flexible electrical interconnection circuit 147 of FIG. 30 includes two conductor layers. The electrical interconnection circuit 147 of FIG. 30 includes a base layer 182, which can include a polymer material, such as polyimide. Conductor layers 186a and 186b can be formed on the top and bottom of the base layer 182 by stamping, lift-off patterning, lithography, and the like. The conductor layers can be copper pads, and in some implementations additional conductor (e.g., plated copper) layers 188a and 188b can be layered over/under the layers 186a and 186b for at least a portion of the flexible electrical interconnection circuit. In some implementations, a conductor (e.g., plated copper) material 196 can interconnect the layers 188a and 188b at one or more locations on flexible electrical interconnection circuit 147 (e.g., at points of connection for light emitters 102 or other components). The conductor material 196 can, for example, extend generally transverse to the other layers to connect the conductor layers 188a and 188b. Coverlay layers 192a and 192b can be positioned above/under the conductor layers 186a and 186b and/or 188a and 188b, using adhesive layers (not shown for simplicity). Connection points such as 194a and 194b in FIG. 30 can be devoid of the coverlay layers 192a and 192b and adhesive layers (on one or both sides) so that the light emitter 102, or other component, can be electrically coupled to the flexible electrical interconnection circuit 147.

Many variations are possible. For example, in some implementations, one or both of the reflector portions 104a or 104b can be integrated onto the flexible electrical interconnection circuit 146. For another example, in some implementations, one or both of the arms 154a or 154b can be integrated with the spacer layers 151 and 152, respectively, for example to reduce the possibility of using an incorrect spacer 151 or 152, to reduce the number of parts, to reduce assembly time, etc. In some implementations, no spacer layer can be positioned below the flexible electrical interconnection circuit 146, and a coating on the flexible electrical interconnection circuit 146 provide electrical insulation between the lower reflector 104b and the flexible electrical interconnection circuit 146. In some implementations, one or both of the spacers 151 and 152 can include multiple spacer layers. For example, in FIG. 26, the upper spacer 151 includes two layers, and the lower spacer 152 also includes two layers.

Various methods can be used to make the illumination systems described herein. FIG. 31 is a flowchart showing an example implementation of a method for making an illumination system. At block 202 of the method 200, an input aperture 106 of a reflector 104 can be optically coupled to a light emitter 102. The reflector 104 can be a substantially etendue-preserving reflector 104, as described herein, and the reflector 104 can be configured to at least partially collimate light propagating from the light emitter 102 in a single plane of collimation (e.g., the xz-plane). At block 204, a light guide 112 can be optically coupled to the output aperture 108 of the reflector. The plane of collimation can be orthogonal to a continuous output surface of the light guide. At least a portion of the continuous output surface can be optically transmissive. The light guide 112 can be configured to receive the at least partially collimated light. The light guide can include a plurality of light extraction features configured to turn the light, for example, to illuminate a display, as discussed herein. In some implementations, the collective action of the plurality of light extraction features can result in light transmission through the continuous output surface.

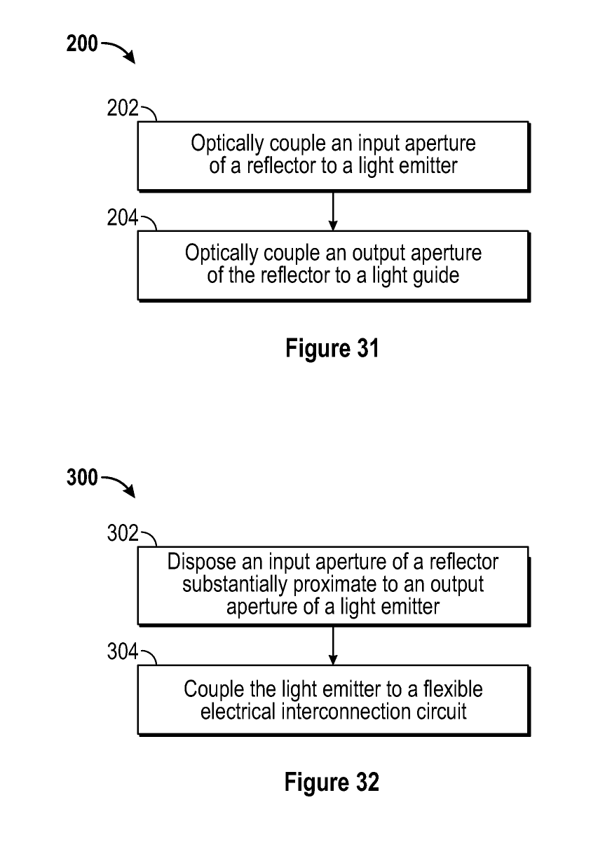

FIG. 32 is a flowchart showing an example implementation of a method for making an illumination system. At block 302 of the method 300, an input aperture 106 of a reflector 104 can be disposed such that an input aperture of the reflector is proximate to (e.g., substantially proximate to) an output aperture of the light emitter 102. At block 304, the light emitter 102 can be coupled to a flexible electrical interconnection circuit 146, which can have a first side 146a and a second side 146b opposite the first side 146a. The electrical interconnection circuit 146 can include surface mounted electrical pathways. The reflector 104 can include an upper shaped reflector sheet 104a on the first side 146a of the electrical interconnection circuit 146 and a lower shaped reflector sheet 104b on the second side 146b of the electrical interconnection circuit 146.

In various implementations discussed herein, a light emitter 102 can be optically coupled to an input aperture 106 of a reflector 104. In some cases, the reflector 104 can substantially preserve etendue of the light emitted by the light emitter 102. In some implementations, an LED or other lighting element can be positioned substantially proximate the input aperture 106 of the reflector 104 such that light is directly coupled into the reflector 104 via the input aperture 106. In some implementations, an LED or other lighting element can be spaced apart from the input aperture 106 of the reflector 104, or can be located remotely, and the light emitter 102 can include a light guide configured to direct light from the LED or other lighting element to the input aperture 106 of the reflector 104. For example, in FIG. 28A, a light guide 164 can direct light from an LED 162 to the input aperture 106 of the reflector 104. In some implementations, an output aperture of the light emitter 102 can be the output aperture of the light guide 164, which can be substantially proximate to the input aperture 106 of the reflector 104. In some implementations, the output aperture light emitter 102 can include a phosphor 166, or other component configured to emit light. In some implementations, disposing the output aperture of the light emitter 102 substantially proximate to the input aperture 106 of the reflector 104 can cause light emitted from the output aperture of the light emitter 102 to impinge on the reflector 104 such that the reflector substantially preserves etendue of the light emitted by the light emitter 102. In some cases, a light emitter 102 that is optically coupled to the input aperture 106 of the reflector 104 can be configured to direct light to the reflector 104 such that the reflector substantially preserves etendue of the light from the light emitter 102.

Various features described herein can be combined to create additional implementations not specifically shown in the drawings. For example, the various edge light sources 100 discussed herein can include a flexible electrical interconnection circuit 146 for providing power and/or signals to the light emitters 102 even where not specifically shown or discussed. Also, the various reflectors 104 shown can use spacers similar to, or the same as, the spacers 151 and 152 shown in FIGS. 26-28A to position the reflector portions 104a and 104b. Also, the lenticular film 142, holographic film 136, and other optical elements, and other vertical stabilizers, can be incorporated into various other implementations discussed herein, even where not specifically shown in the drawings. Various other features discussed above can be combined with other implementations discussed herein, such as the engagement features 116 and 114 on the reflector 104 and light guide 112, shown, for example, in FIGS. 12 and 13.

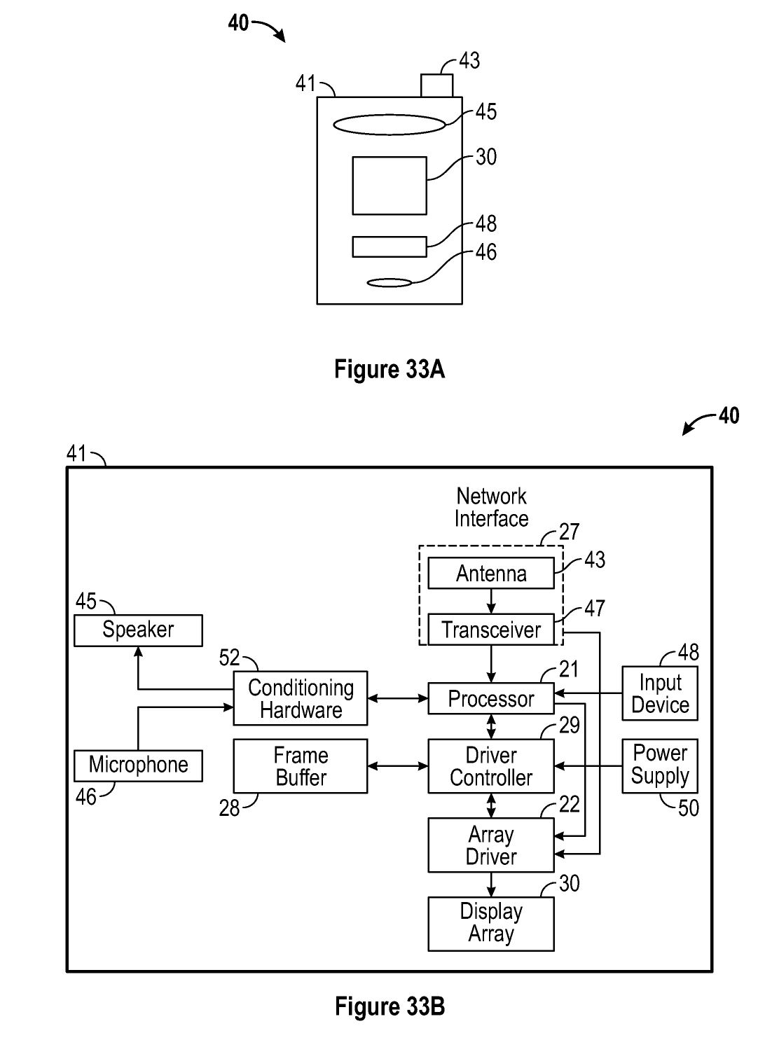

FIGS. 33A and 33B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 33B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system comprising:
a flexible electrical interconnection circuit having a first side and a second side opposite the first side, the electrical interconnection circuit including a plurality of surface mounted electrical pathways;
a light emitter coupled to the electrical interconnection circuit; and
a reflector having an input aperture that is substantially proximate to an output aperture of the light emitter, the reflector including:
an upper shaped reflector sheet on the first side of the electrical interconnection circuit; and
a lower shaped reflector sheet on the second side of the electrical interconnection circuit.

2. The illumination system of claim 1, further comprising:
an upper spacer between the first side of the electrical interconnection circuit and the upper shaped reflector; and
a lower spacer between the second side of the electrical interconnection circuit and the lower shaped reflector.

3. The illumination system of claim 2, wherein the upper spacer is thicker than the lower spacer.

4. The illumination system of claim 2, wherein the upper spacer and the lower spacer have a substantially similar thickness.

5. The illumination system of claim 1, wherein the light emitter is mounted to the first side of the electrical interconnection circuit.

6. The illumination system of claim 1, wherein the light emitter is mounted to an end of the electrical interconnection circuit.

7. The illumination system of claim 6, wherein the light emitter includes a blue light-emitting diode (LED) chip and a yellow phosphor and the illumination system further comprising a light guide region between the blue LED chip and the yellow phosphor.

8. The illumination system of claim 1, wherein the light emitter includes at least one of a light emitting diode (LED) chip, an organic light emitting diode (OLED), and a phosphor layer.

9. The illumination system of claim 1, wherein the reflector includes a substantially etendue-preserving reflector optically coupled to the light emitter, the reflector configured to at least partially collimate light propagating from the light emitter in a single plane of collimation.

10. The illumination system of claim 1, wherein a volume between the upper shaped reflector sheet and the lower shaped reflector sheet is occupied by air.

11. The illumination system of claim 1, wherein the reflector includes a vertical stabilizer.

12. The illumination system of claim 11, wherein the vertical stabilizer includes a lenticular film.

13. A display device comprising:
the illumination system of claim 1;
an array of display elements, and
a light guide optically coupled to the reflector of the illumination system, the light guide configured to turn light propagating from the reflector towards the display elements.

14. The display device of claim 13, wherein the display elements include at least one of liquid crystal displays (LCD), electrophoretic displays, and interferometric modulators (IMOD).

15. The display device of claim 13, wherein the display elements are reflective.

16. An apparatus comprising:
a display including the illumination system of claim 1;
a processor that is configured to communicate with the display, the processor being configured to process image data; and
a memory device that is configured to communicate with the processor.

17. The apparatus of claim 16, further comprising a driver circuit configured to send at least one signal to the display.

18. The apparatus of claim 17, further comprising a controller configured to send at least a portion of the image data to the driver circuit.

19. The apparatus of claim 16, further comprising an image source module configured to send the image data to the processor.

20. The apparatus of claim 19, wherein the image source module includes at least one of a receiver, transceiver, and transmitter.

21. The apparatus of claim 16, further comprising an input device configured to receive input data and to communicate the input data to the processor.

22. A illumination system comprising:
means for flexibly interconnecting electrical components, the interconnecting means having a first side and a second side opposite the first side, the interconnecting means including a plurality of surface mounted electrical pathways;
a light emitter coupled to the interconnecting means; and
means for reflecting light propagating from the light emitter, the reflecting means having an input aperture that is substantially proximate to an output aperture of the light emitter, the reflecting means including:
upper reflecting means on the first side of the interconnecting means; and
lower reflecting means on the second side of the interconnecting means.

23. The illumination system of claim 22, wherein the interconnecting means includes a flexible electrical interconnection circuit, or wherein the reflecting means includes a reflector, or wherein the upper reflecting means includes an upper shaped reflector, or wherein the lower reflecting means includes a lower shaped reflector.

24. The illumination system of claim 22, further comprising:
upper means for spacing the first side of the interconnecting means and the upper reflecting means; and
lower means for spacing the second side of the interconnecting means and the lower reflecting means.

25. The illumination system of claim 24, wherein the upper spacing means includes an upper spacer, or wherein the lower spacing means includes a lower spacer.

26. The illumination system of claim 22, wherein the reflecting means includes means for vertical stabilizing.

27. The illumination system of claim 26, wherein the vertical stabilizing means includes a vertical stabilizer.

28. A method of making an illumination system, the method comprising:
disposing an input aperture of a reflector substantially proximate to an output aperture of a light emitter; and
coupling the light emitter to a flexible electrical interconnection circuit having a first side and a second side opposite the first side, the electrical interconnection circuit including a plurality of surface mounted electrical pathways, the reflector including an upper shaped reflector sheet on the first side of the electrical interconnection circuit and a lower shaped reflector sheet on the second side of the electrical interconnection circuit.

29. The method of claim 28, further comprising:
providing an upper spacer between the first side of the flexible electrical interconnection circuit and the upper shaped reflector sheet; and
providing a lower spacer between the second side of the flexible electrical interconnection circuit and the lower shaped reflector sheet.

30. The method of claim 28, further comprising providing a vertical stabilizer for the reflector.
